(19) United States
(12) Patent Application Publication
(10) Pub. No.: US 2026/0290712 A1
(43) Pub. Date: Sep. 24, 2026

(54) Aqueous Supercapacitors with Ultrawide Potential Window and pH Independent Stability Using Electrodes of Graphene Oxide Nanoribbons/Fe-MOFs Nanocomposite

(71) Applicant: The American University in Cairo, New York, NY (US)

(72) Inventors: Ehab El Sawy, Cairo (EG); Taeho Yoon, Cairo (EG); Mohamed Omar Abdel-Salam, Cairo (EG); Asmaa R. Heiba, Cairo (EG)

(21) Appl. No.: 19/213,029

(22) Filed: May 20, 2025

Related U.S. Application Data
(60) Provisional application No. 63/650,494, filed on May 22, 2024.

(51) Int. Cl. H01G 11/86; C25B 1/04; C25B 11/073; H01G 11/36

(52) U.S. Cl. CPC H01G 11/86; H01G 11/36; C25B 1/04; C25B 11/073

(57) ABSTRACT

The growing role of renewable energy sources in power generation has significantly spurred the advancement of energy storage technologies, with supercapacitors (SCs) receiving considerable attention. In this invention graphene oxide nanoribbons (GONRs), iron-based metal-organic frameworks (Fe-MOFs), and GONRs/Fe-MOFs composite were synthesized and evaluated as electrode materials for SCs applications achieving ultra-wide potential. The developed method and supercapacitor electrodes provide a promising path for employing MOF-based SCs using aqueous electrolytes and GONRs.

### CROSS-REFERENCE TO RELATED APPLICATIONS

This application claims priority from U.S. Provisional Patent Application 63/650,494 filed May 22, 2024, which is incorporated herein by reference.

### FIELD OF THE INVENTION

The invention relates to methods and devices for aqueous supercapacitor technology.

### BACKGROUND OF THE INVENTION

In today's world, energy is a primary focus, given its indispensable role in industrial and domestic applications. With the rapid growth of the global economy, the consumption of fossil fuels has surged dramatically worldwide. As a result, finding viable alternatives to replace fossil fuels has become essential. Renewable sources are critical for reducing reliance on fossil fuels, with electrochemical energy storage systems being at the heart of this solution to maintain a stable energy supply and counter the intermittent nature of renewable sources. Consequently, the potential to revolutionize energy storage into an eco-friendly, scalable, and sustainable technology has motivated researchers to explore innovative solutions.

Supercapacitors (SCs) have gained significant attention as high-power energy storage devices that bridge the gap between conventional capacitors and batteries. SCs offer crucial advantages, including exceptional cycling stability, high power density, and ultra-fast charge-discharge capabilities. Two primary strategies have emerged to enhance the performance of SCs: optimizing electrode materials and developing advanced electrolytes.

For electrode materials, carbon-based materials, in particular, have gained significant attention due to their cost-effectiveness, abundance, and excellent electrical conductivity (105 S/m) [8]. Multiwalled carbon nanotubes (MWCNTs) stand out as a promising electrode material for SCs because of their chemical stability, durability, and superior conductivity. However, low specific capacitance and low electrochemical surface area often limit their practical application. The present invention provides technology that addresses these limitations.

### SUMMARY OF THE INVENTION

The present invention provides a method of making a method of fabricating a supercapacitor electrode with enhanced electrochemical properties for energy storage systems. The method can be characterized by the following steps. First, solid samples of graphene oxide nanoribbons (GONRs) are synthesized by oxidative unzipping of Multi-Walled Carbon Nanotubes (MWCNTs). In this first step, the unique aspects of the GONRs synthesis is strict control temperature (<20 degrees Celsius during KMnO₄ addition) and gradual dilution (400 mL H₂O added slowly in an ice bath to prevent over-oxidation or structural damage. As many methods add oxidants at higher temperatures or omit ice baths, leading to inconsistent unzipping or defects, the approach in this invention yields higher-quality GONRs with fewer edge defects. Another aspect in this first step is the immediate use of fresh GONRs suspension for composites (avoiding drying/re-dispersion). As studies have reported GONRs aggregation after drying, the method in this invention preserves dispersion quality, which is critical for electrochemical performance. Yet another aspect of this first step is an about 24-hour stirring in H₂SO₄ or 4-hour reaction at 85 degrees Celsius which achieves higher yield/unzipping efficiency.

The second step of the method is characterized by hydrothermally making a powder of iron-metal-organic frameworks (Fe-MOFs) using a hydrothermal method. In this second step, the unique aspects of the hydrothermal Fe-MOF synthesis, focuses on improvements in yield, purity, crystallinity, and/or performance. Key aspects to achieve those improvements are a specific molar ratio of FeCl₃·6H₂O (1.63 mmol) to benzene-1,4-dicarboxylic acid (0.827 mmol) (~2:1 metal: ligand) in 60 mL DMF. As others often uses 1:1 ratios or different solvents (e.g., water/ethanol mixtures). Another aspect of this second step is an about 8-hour reaction at 150 degrees Celsius (vs. 12-24 hrs in some literature) while maintaining high yield. As shorter reaction times reduce energy costs, that is useful for scalability.

The third step of the method is characterized by physically mixing the solid samples of GONRs and powder of Fe-MOFs while maintaining a substantial weight ratio of 1:1 in the mixing of the solid samples and powder and thereby making a GONRs/Fe-MOFs composite. The substantial 1:1 weight ratio (or at best 1:1) of GONRs to Fe-MOFs in the composite is critical, as it maximizes synergistic effects for electrochemical performance. In one variation, each value in the ratio could be defined as 0.9 to 1.1, or any value between 0.9 and 1.1, or any value between 0.95 and 1.05.

The fourth step of the method is characterized ultrasonically mixing the physical mixing the GONRs/Fe-MOFs composite for at least 1 hour at about 300 Watt and at room temperature ranging from 24 degrees Celsius to 26 degrees Celsius. Ultrasonication was applied for about 1 hour at 300 W to improve mixing without impacting the formation of the Fe-MOFs' skeletal structure at (24-26 degrees Celsius) room temperature.

The supercapacitor electrode exhibits an operational voltage range to 2.3 V in an aqueous electrolyte when configured in a symmetric cell. This extended potential window, unprecedented for aqueous systems, is attributed to the synergistic effects of the GONRs/Fe-MOFs composite: the Fe-MOFs stabilize the oxygen functional groups of GONRs, suppressing electrolytic decomposition, while the conductive GONRs mitigate charge localization at high potentials. Notably, this 2.3 V window exceeds typical aqueous supercapacitors (typically ≤1.8 V) and rivals some organic electrolytes.

The supercapacitor electrode incorporating GONRs/Fe-MOFs composite demonstrates outstanding energy storage performance, achieving:
Energy densities of 60.1 Wh/kg (1M H₂SO₄), 58 Wh/kg (saturated K₂SO₄), and 10.2 Wh/kg (1M KOH) at 1 A/g current density,
Power densities of 10,448 W/kg (1M H₂SO₄), 8,300 W/kg (saturated K₂SO₄), and 14,620 W/kg (1M KOH) at 10 A/g current density

This exceptional performance across acidic, neutral, and alkaline electrolytes highlights the composite's versatility and optimized charge storage capabilities.

The capacitance of the GONRs/Fe-MOFs composite was found to be 502, 493, and 403 F/g at a current density of 1 A/g in 1M H₂SO₄, saturated K₂SO₄, and 1M KOH. Even at a higher current density of 10 A/g, the Cs values were 295, 149, and 132 F/g, respectively, retaining most of their capacitance and indicating their suitability for supercapacitor applications.

The composite demonstrated exceptional cycling stability in all electrolytes, retaining >95% of its initial capacitance after 10,000 cycles. The electrochemical stability of the GONRs/Fe-MOFs composite was rigorously assessed through 10,000 galvanostatic charge-discharge (GCD) cycles at 10 A/g across three aqueous electrolytes:
1M KOH (alkaline, 1.3 V window)
1M H₂SO₄ (acidic, 2.0 V window)
Saturated K₂SO₄ (neutral, 2.3 V window)

This performance-particularly under the industry-standard 10 A/g stress test that confirms its structural robustness and electrochemical reversibility, making it a promising candidate for long-life supercapacitor applications.

### BRIEF DESCRIPTION OF THE DRAWINGS

FIG. 1 shows according to an exemplary embodiment of the invention a scheme for the preparation of GONRs/Fe-MOFs.

FIGS. 2A-E show according to exemplary embodiments of the invention TEM images of (FIG. 2A) GONRs, (FIG. 2B) Fe-MOFs, and SEM images of (FIG. 2C) Fe-MOFs, and (FIG. 2D) Fe-MOFs//GONRs, and (FIG. 2E) SAED of Fe-MOFs//GONRs. FIG. 2F presents a simulated TEM image, created using software (3D-max) for FIG. 2D, visually demonstrating how the Fe-MOFs are distributed on the surface of the GONRs.

FIGS. 3A-B show according to exemplary embodiments of the invention (FIG. 3A) XRD patterns and (FIG. 3B) FT-IR spectra of GONRs, Fe-MOFs, and GONRs/Fe-MOFs.

FIGS. 4A-D show according to exemplary embodiments of the invention XPS spectra of GONRs, Fe-MOFs, and GONRs/Fe-MOFs: (FIG. 4A) fast survey scan mode, (FIG. 4B) Fe 2p, (FIG. 4C) C 1s, and (FIG. DA) O 1s.

FIGS. 5A-F show according to exemplary embodiments of the invention (FIGS. 5A-B) CVs at scan rates 20 mV/s, (FIGS. 5C-D) the dependence of log current at 0.1 V on log scan rate following the power-law, (FIGS. 5E-F) the contribution (%) of non-diffusion-controlled (solid line+symbol) and diffusion-controlled (dashed line+hollow symbol) charge storage, for Fe-MOFs and GONRs/Fe-MOFs composite at different electrolyte, respectively.

FIGS. 6A-F show according to exemplary embodiments of the invention (FIGS. 6A-B) GCD response at current density 2 A/g, (c FIGS. 6C-D) Ragone plot at various current densities (1-10 A/g), (FIGs. E-F) Nyquist plot of the EIS at OCP (the equivalent circuit used for data fitting is shown in the inset), all of the figure for Fe-MOFs and GONRs/Fe-MOFs composite at different electrolyte, respectively.

FIGS. 7A-C show according to exemplary embodiments of the invention (FIGS. 7A-C) the cycling stability over 5000 GCD cycles at 10 A/g in the three-electrode system for Fe-MOFs and GONRs/Fe-MOFs composite at different electrolytes.

FIGS. 8A-F show according to exemplary embodiments of the invention for symmetric two electrode systems (FIG. 8A) CVs of GONRs/Fe-MOFs composite in 1M H₂SO₄, 1 M KOH, and saturated solution (~0.7 M) of K₂SO₄, at a scan rate of 20 mV/s, (FIG. 8B) the GCD of GONRs/Fe-MOFs composite in the different electrolytes at a current density of 1 A/g, (FIG. 8C) Ragone plot at various current densities (1-10 A/g), (FIG. 8D) Nyquist plot of the EIS findings at OCP (data fitting equivalent circuit is shown in the inset), (FIG. 8E) Cycling stability over 10000 GCD cycles at 10 A/g in different electrolytes, (FIG. 8F) CVs before and after 10000 cycles at a scan rate of 100 mVs-1 for the different electrolytes.

### DETAILED DESCRIPTION

To overcome these challenges, researchers have turned to modified carbon structures, such as graphene oxide nanoribbons (GONRs), which are formed by unwrapping MWCNTs. Unlike their precursor, GONRs feature high electrochemical surface area and exposed edge structures enriched with oxygen functional groups, enhancing their hydrophilicity and dispersibility in aqueous solutions and facilitating ion diffusion within their layered structure. Additionally, these functional groups provide active sites for material integration while maintaining a 1D graphene-like lattice structure. As a result, GONRs present a desirable option for next-generation energy storage systems, combining improved performance with structural versatility.

Metal-organic frameworks (MOFs) represent another promising class of materials with tunable properties that can be optimized by altering their organic ligands and metal centers to enhance electrical conductivity. MOFs are used in energy storage applications, including batteries, SCs, and catalysis, where they facilitate efficient charge storage and transfer. Despite their potential, iron-based MOFs (Fe-MOFs) have been relatively understudied in SCs applications.

Applying Fe-MOFs faces challenges such as low conductivity, unfavorable morphology, and poor cycling stability. Therefore, researchers have explored combining Fe-MOFs with conductive carbon-based materials to overcome these limitations. Such hybrid structures leverage MOFs' high surface area and redox activity while compensating for their inherent conductivity issues. Additionally, combining MOFs with hydrophilic carbon-based materials shortens ion diffusion pathways within the electrolyte, enabling faster charge transfer, higher specific capacity, and improved device performance. For instance, combining Fe-MOF with graphene oxide significantly improved both their conductivity and capacitance retention.

Given these advantages, the present invention employs a physical approach based on electrostatic interactions to anchor Fe-MOFs onto GONRs to enhance the stability and efficiency of supercapacitor electrodes. This strategy addresses the conductivity limitations of Fe-MOFs and takes advantage of the high wettability, dispersibility, and edge-functionalized structure of GONRs, creating a composite material with superior electrochemical properties for next-generation energy storage systems.

While electrode materials are crucial for SCs performance, the electrolyte plays an equally vital role by facilitating charge balance during energy storage. An electrolyte should exhibit high ionic conductivity, stability, and environmental safety. Among available options, aqueous electrolytes stand out due to their cost-effectiveness, natural abundance, eco-friendliness, and superior ionic conductivity, all of which significantly enhance specific capacitance in SCs applications.

Aqueous electrolytes are typically classified into three categories: acidic, neutral, and alkaline solutions, each with distinct cation-anion combinations that influence SCs performance. Interestingly, the choice of conductive ions can lead to substantial variations in electrochemical behavior. Despite this understanding, few studies have examined how MOFs-based electrodes perform in acidic aqueous environments.

To address this knowledge gap, the present invention further evaluates the electrochemical performance of Fe-MOFs and GONRs/Fe-MOFs composite across three different aqueous electrolytes: 1 M H₂SO₄ (acidic), 1 M KOH (alkaline), and a saturated (~0.7 M) K₂SO₄ solution (neutral). This comprehensive approach will provide valuable insights into how electrolytes affect the charge storage mechanisms and stability of the proposed Fe-MOFs and their composite with GONRs, potentially revealing optimal conditions for maximizing supercapacitor performance.

By systematically comparing performance across these electrolyte systems, the inventors aimed to establish more evident structure-property relationships that could guide future electrolyte selection for MOF-based energy storage devices. This invention and study are particularly relevant given the growing demand for environmentally benign, high-performance supercapacitors with tunable electrochemical characteristics.

This invention presents a novel approach to supercapacitor electrode development by synthesizing a GONRs/Fe-MOFs composite. The Fe-MOFs were prepared using a hydrothermal method, while GONRs were obtained through oxidative unzipping of carbon nanotubes. These components were combined via physical mixing to create the GONRs/Fe-MOFs composite. The GONRs/Fe-MOFs composite demonstrated exceptional electrochemical performance across multiple metrics. A wide potential window of 2.2 V (three-electrode) and 2.3 V (two-electrode) was achieved in aqueous electrolytes, particularly in K₂SO₄ electrolytes. The material exhibited significant energy storage capabilities, delivering 60 Wh/kg at 1 A/g in H₂SO₄ and an exceptional power density of 14,580 W/kg at 10 A/g in K₂SO₄. Notably, it maintained a high specific capacitance of 502 F/g at 1 A/g in acidic conditions while showing remarkable cycling stability by retaining performance over 5000 charge-discharge cycles in two- and three-electrode configurations.

These results represent significant progress in supercapacitor technology, as the composite simultaneously addresses three critical challenges: voltage window limitations, energy/power density trade-offs, and long-term stability. The successful integration of Fe-MOFs with GONRs through this facile preparation method suggests a promising pathway for developing high-performance, durable energy storage systems suitable for demanding applications.

### Experimental

### Materials

N, N-dimethylformamide (DMF), acetic acid (>99%), Iron chloride hexahydrate (FeCl₃·6H₂O, 99.99%), benzene-1,4-dicarboxylic acid (98%), Potassium Hydroxide (KOH), Potassium Sulfate (K₂SO₄), Polyvinylidene Fluoride (PVDF), Potassium Permanganate (KMnO₄), sulfuric acid (H₂SO₄, 98%), nitric acid (HNO₃, 70%), and acetone were all purchased from Sigma-Aldrich. Hydrogen Peroxide (H₂O₂, 30%) and hydrochloric Acid (HCl, 32%) were purchased from Merck. Multi-Walled Carbon Nanotubes, MWCNTs, (outer diameter of 20-40 nm) CVD-generated molecules from the Egyptian Petroleum Research Institute (EPRI, Cairo, Egypt) were used. The graphite sheet (thickness of 0.5 mm, China) is used for current collection in the supercapacitor device fabrication. Ultrapure water used in all experiments was obtained by reverse osmosis followed by filtration using ion exchange resin to afford a resistivity of >18.3 MΩ·cm.

### Preparation of GONRs

GONRs were synthesized using the oxidative unzipping of the MWCNTs, following a procedure detailed by the inventors (Heiba et al., Graphene oxide nanoribbons (GONRs) as pH-tolerant electrodes for supercapacitors: Effect of charge carriers and loading, J. Energy Storage 83 (2024) 110762. https://doi.org/10.1016/j.est.2024.110762) and modified from the method described by Kosynkin et al. (Kosynkin et al., Longitudinal unzipping of carbon nanotubes to form graphene nanoribbons, Nature 458 (2009) 872-876. https://doi.org/10.1038/nature07872). Briefly, 0.3 g of MWCNTs were mixed with 120 mL of concentrated H₂SO₄ and stirred at room temperature for 24 hours. Then, 1.5 g of KMnO₄, an oxidizing agent, was slowly added while maintaining the reaction temperature below 20° C. The mixture was placed in an ice bath, and 400 mL of deionized water was gradually added, followed by vigorous stirring for 30 minutes to dilute the slurry. The mixture was heated to 85° C. and stirred for 4 hours. After removing it from the ice bath, 60 mL of H₂O₂ (30%) and 200 mL of deionized water were added to prevent the formation of insoluble manganese dioxide (MnO₂) before washing. The GONRs sample was washed several times with 10% HCl and deionized water until the pH was nearly neutral. To avoid GONRs stacking, the freshly prepared GONRs suspension was used for composite formation and electrochemical testing. The suspension was filtered through a 0.45 μm nylon membrane, cleaned with ethanol and deionized water, and vacuum-dried at 60° C. to obtain solid samples for physical characterization. The resulting black granules of GONRs were collected as solid samples.

### Preparation of Fe-MOFs and a GONRs/Fe-MOFs Composite

Upgraded procedures described by Taylor-Pashow et al. (Taylor-Pashow et al., Postsynthetic modifications of iron-carboxylate nanoscale metal-organic frameworks for imaging and drug delivery, J. Am. Chem. Soc. 131 (2009) 14261-14263. https://doi.org/10.1021/ja906198y) and Skobelev et al. (Skobelev et al., Solvent-free allylic oxidation of alkenes with 02 mediated by Fe- and Cr-MIL-101, J. Catal. 298 (2013) 61-69. https://doi.org/10.1016/j.jcat.2012.11.003) were used to prepare the Fe-MOFs. In this synthesis process, a mixed solution of 1.63 mmol of FeCl₃·6H₂O, 0.827 mmol of benzene-1,4-dicarboxylic acid, and 60 mL of DMF were transferred to a 100 ml Teflon reactor. Then, the reactor was moved into the oven and heated to 150° C. for 8 hrs. After the reaction, the resulting orange suspension was centrifuged, and a double treatment in ethanol and DMF was used to obtain a purified product. An orange powder was obtained after drying in a vacuum at 50° C.

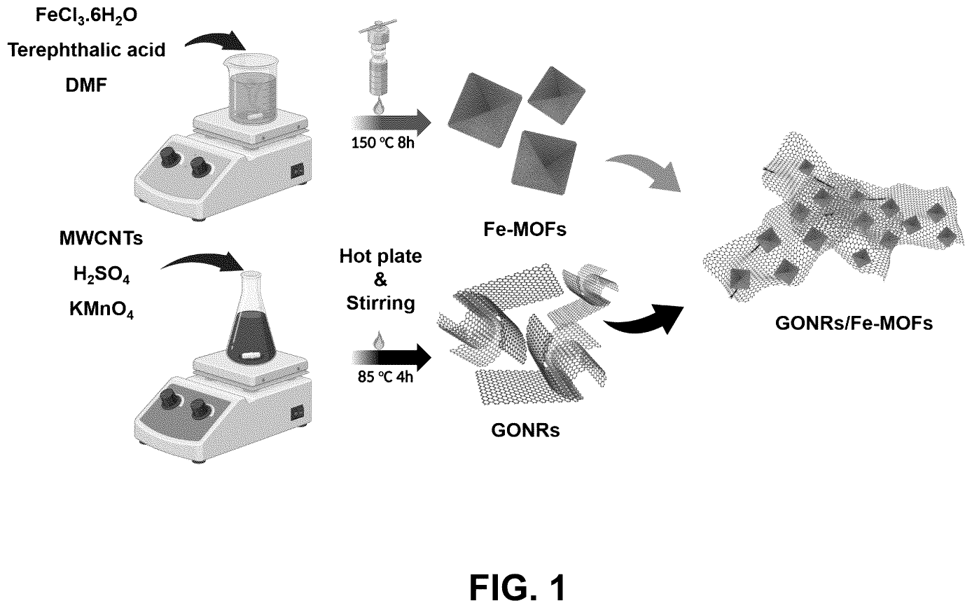

The composite of GONRs/Fe-MOFs was produced through physical mixing, maintaining a (1:1) weight ratio, as shown in FIG. 1. Ultrasonication was applied for one hour at 300 W to improve mixing without impacting the formation of the Fe-MOFs' skeletal structure at room temperature.

Electrochemical measurements were performed directly on the mixture without additional filtration or washing. Furthermore, the resulting mixture was vacuum-dried at 60° C. to produce solid samples for subsequent physical characterization.

### Characterization of the Prepared Samples

Various techniques were used to characterize the synthesized materials thoroughly. The crystal structure was analyzed using X-ray diffraction (XRD), employing a PANalytical X′Pert PRO MPD system (Malvern Panalytical, UK) with Cu Kα radiation source (λ=1.5406 Å) that operated at 40 kV, 30 mA, and a scan rate of 1°/min. Fourier transform infrared spectroscopy (FT-IR, JASCO spectrometer-model 6300 type A) was used to identify the functional groups in the materials, covering a range of 400-4000 cm⁻¹, with KBr as the reference.

The morphology and microstructure were examined using field emission scanning electron microscopy (FE-SEM S4800 system, Hitachi, Ltd., Japan) at an acceleration voltage of 10.0 kV, with samples mounted on aluminum stubs using carbon tape. High-resolution transmission electron microscopy (HRTEM) was performed using a JOEL JEM-2100, and selected area electron diffraction (SAED) patterns were captured for the GONRs/Fe-MOFs samples. For HRTEM and SAED, the samples were prepared by depositing the material dispersion onto copper-coated carbon grids and air drying. X-ray photoelectron spectroscopy (XPS, Thermo Fisher-Scientific ESCALAB 250Xi, USA) was used to analyze the composition and surface chemistry of the materials. Thermogragemetric analysis (TGA) for measuring the thermal stability of the prepared materials by (TA Q50, korea). The XPS system utilized Al Kα radiation, with ion-source energy ranging from 100 V to 3 keV. The XPS data was fitted and deconvoluted using CASA XPS software. The total Fe contents of the electrolyte, after the electrochemical stability test, were measured using an Inductively coupled plasma optical emission spectrometry (ICP-OES) with an iCAP 7000 system (Thermo Fisher Scientific, Waltham, MA, USA).

### Electrochemical Characterization

Electrochemical measurements were performed on a BioLogic-SP300 potentiostat/galvanostat. A graphite sheet served as the working electrode (current collector), with 1 M KOH, saturated K₂SO₄ (approximately 0.7 M), and 1 M H₂SO₄ solutions as supporting electrolytes. A gold coil was employed as the counter electrode. In contrast, the reference electrode was selected based on the electrolyte environment: Hg/HgO/1 M KOH (E°=0.14 V vs. SHE) for alkaline media, Hg/Hg₂Cl₂/saturated KCl (E°=0.241 V vs. SHE) for neutral media, and Hg/HgSO₄ (E°=0.674 V vs. SHE) for acidic media. The suspension of the active material used for the working electrode fabrication is prepared by ultrasonication of 4 mg of the active material (Fe-MOFs, GONRs, or their composite) and 0.4 mg of PVDF in 5 ml of DMF. For the deposition of the materials onto the graphite sheet, a consistent mass loading of ~1 mg/cm² was applied to the graphite sheet by the airbrush coating technique. All the electrochemical measurements were corrected to only the active material loading.

Galvanostatic charge-discharge (GCD), cyclic voltammetry (CV), and electrochemical impedance spectroscopy (EIS) were utilized to evaluate supercapacitive performance and power capabilities in three and two-electrode systems. GCD was measured at various current densities (1-10 A/g) to determine charge/discharge time. CV tests were measured at varying scan rates (2-100 mV s⁻¹) to investigate the electrochemical response and capacitive behavior of the materials. Furthermore, the electrochemical surface area (ECSA) was estimated from the CV curves that obtained in the non-Faradaic potential region, set at≈1.2 V Vs. the reversible hydrogen electrode (RHE), where only double-layer charging occurs without Faradaic reactions. The capacitive (non-Faradaic) current at this potential was plotted as a function of scan rate, and the slope of the resulting linear relationship provided the double-layer capacitance (C_{DL}). The ECSA was then calculated using the Equation 1:

$$ECSA = \frac{{C}_{D L}}{{C}_{s}} \qquad ( 1 )$$

where C_{S} represents the specific capacitance per unit area. Based on literature, C_{S} typically ranges from 20 to 80 μF cm⁻², depending on the electrode material and surface roughness. However, a value of 40 μF cm⁻² is most commonly adopted for carbon-based materials and transition metal oxides due to its broad applicability and consistency in reported studies. The EIS was conducted over a frequency range of 0.1 Hz-100 kHz using an amplitude of 5 mV at the Open-Circuit Potential (OCP). GONRs/Fe-MOFs composite is used to assemble a symmetric device for both the positive and negative electrodes in the two-electrode system. The stability of the materials was evaluated by 10000 GCD cycles at 10 A/g at different electrolytes, with the potential window being 1.3, 2, and 2.3 V for alkaline, acidic, and neutral electrolytes, respectively. All electrochemical measurements were performed at room temperature and IR-corrected.

The specific capacitance Cₛ (F/g) was calculated from GCD by Equation 2, where I (A) and ΔV(V) are the applied current and potential window, respectively, Δt(s) is the discharging time and m (g) is the weight of the electrode material.

$${C}_{s} = \frac{I Δ t}{m Δ V} \qquad ( 2 )$$

Equations 3 and 4 were used to calculate the energy density E (Wh/kg) and power density P (W/kg), respectively.

$$E = 0 \text{.5} C Δ {V}^{2} / 3.6 \qquad ( 3 )$$

$$P = \frac{E}{Δ t} \qquad ( 4 )$$

For profiling the I (v), Equations 5 and 6 were used to calculate the contribution of surface- and diffusion-derived currents.

$${I}_{V} = {K}_{1} v + {K}_{2} {v}^{0.5} \qquad ( 5 )$$

$${I}_{V} / {v}^{0.5} = {K}_{1} {v}^{0.5} + {K}_{2} \qquad ( 6 )$$

where I_{(V)} is a potential dependent current obtained from CV at different scan rates, v is the applied scan rate (mV/s), and K₁ and K₂ are two constants that could be obtained from the slope and intercept of I_{V}/v^{0.5} vs. v^{0.5} linear relationship, respectively. The K₁v and K₂v^{0.5} terms represent the surface-controlled and diffusion-controlled current contributions, respectively.

### Results

### Materials Characterization

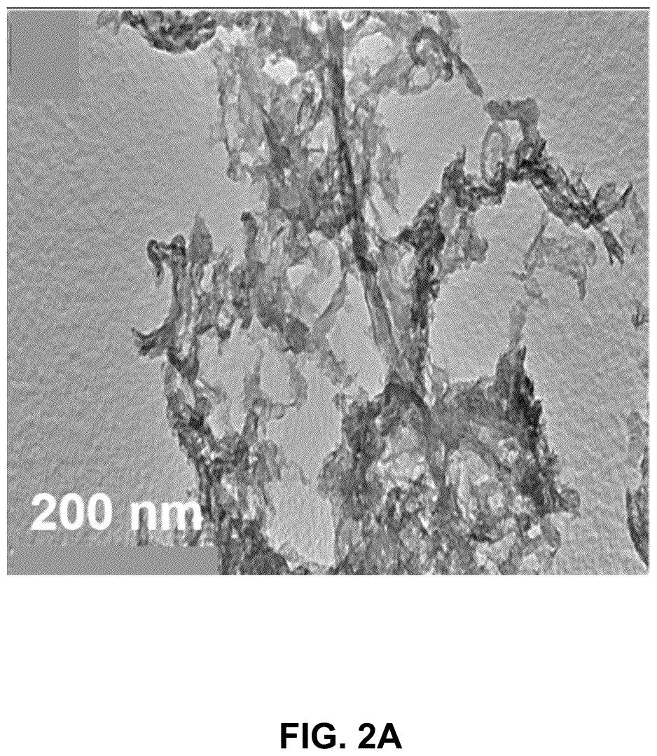

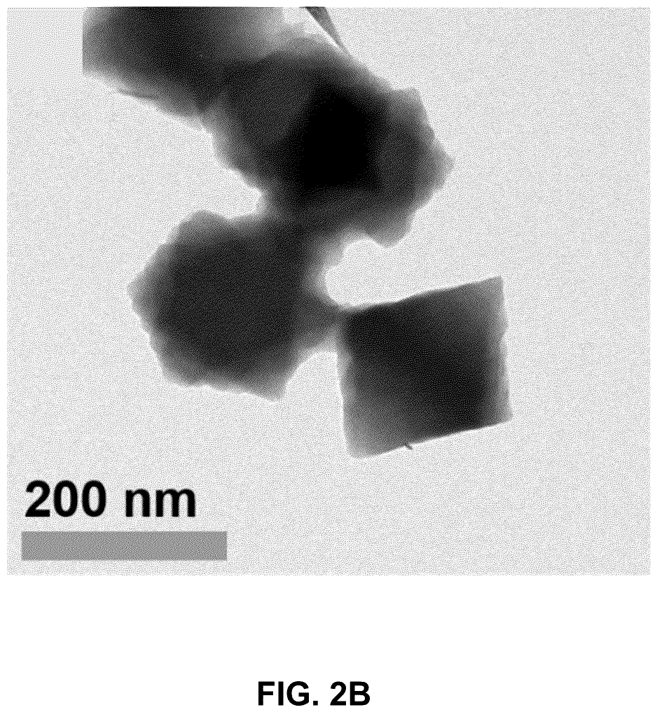

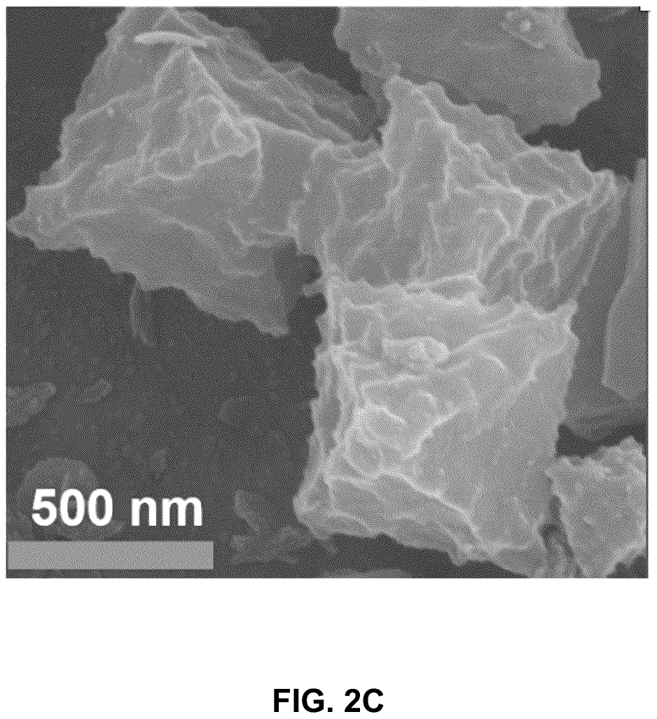

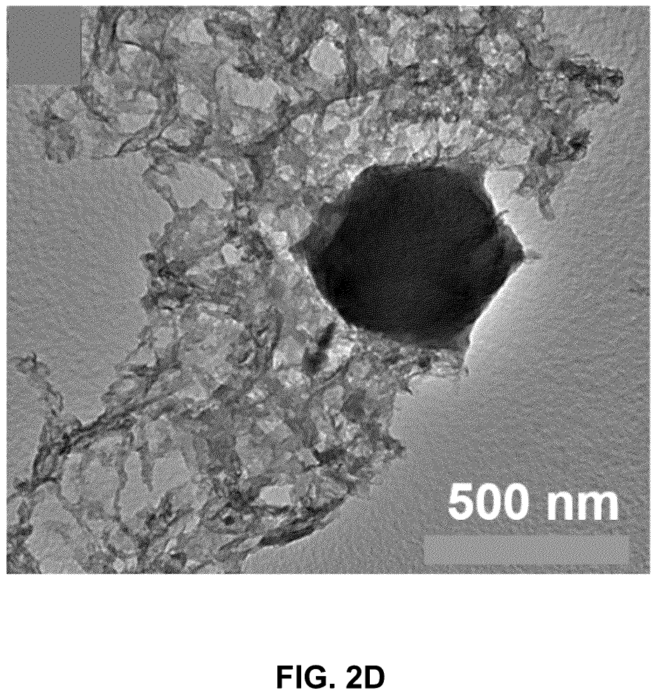

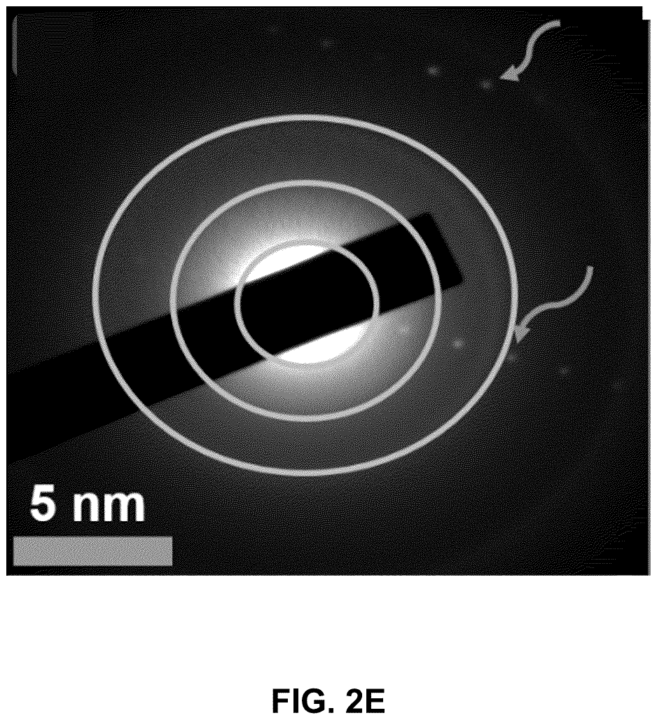

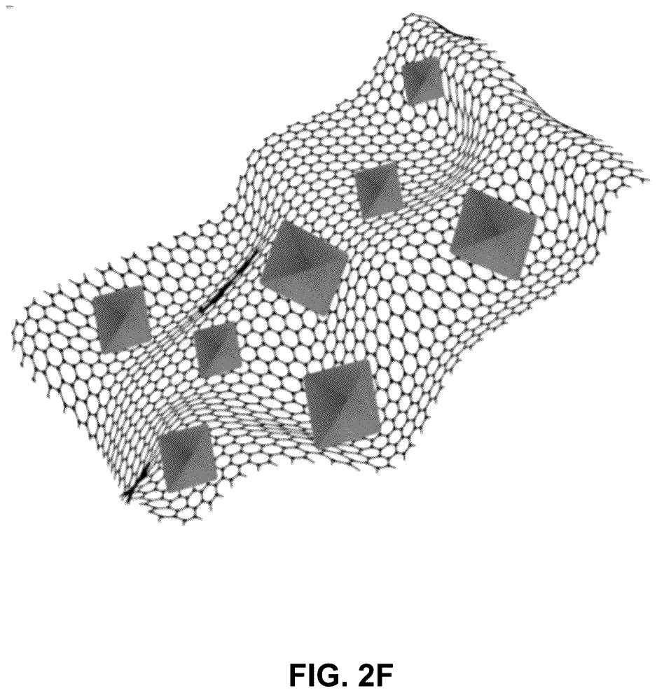

The morphological analysis of the GONRs, Fe-MOFs, and GONRs/Fe-MOFs composite was conducted using FE-SEM and TEM, as depicted in FIGS. 2A-F. The TEM image in FIG. 2A reveals the lamellar layers of GONRs, confirming that the MWCNTs were successfully unwrapped longitudinally to form GONRs. Meanwhile, the TEM and SEM images of Fe-MOFs produced via the hydrothermal heating method show a uniform octahedral morphology with a size of a few hundred nanometers. The sample surface features a porous frame (blade-shaped) derived from MOFs, as illustrated in FIGS. 2B and 2C, which should enhance the flexibility of the ion diffusion path within the MOF structure, leading to faster ion transport [30]. The successful mixing of GONRs with Fe-MOFs increases the exposed surface area of GONRs and enhances the Fe-MOFs' conductivity and their contribution to the charge storage process. The TEM image of the GONRs/Fe-MOFs composite, shown in FIG. 2D, confirms the successful integration of Fe-MOFs with GONR layers. The SAED of the GONRs/Fe-MOFs, presented in FIG. 2E, indicates the successful preparation of highly crystalline Fe-MOFs (shown as dots) and amorphous GONRs (indicated as rings).

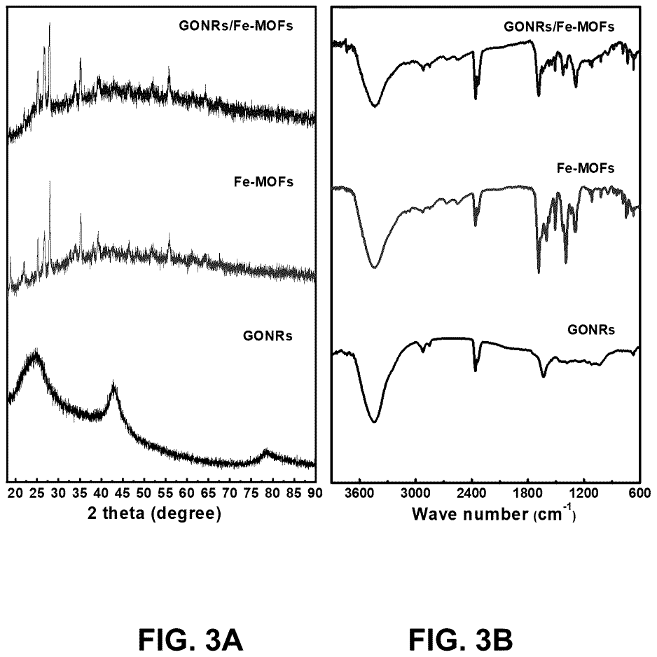

The crystalline structure of the prepared materials GONRs, Fe-MOFs, and GONRs/Fe-MOFs composite were studied by XRD, and the XRD patterns are shown in FIG. 3A. The XRD pattern of GONRs displays three distinct peaks at 20 angles of 24.4°, 42.8°, and 78.5°, corresponding to the (002), (100), and (006) crystal plane with a d-spacing of 0.36 nm, 0.21 nm, and 0.12 nm, respectively. This XRD pattern aligns with previously reported GONRs' structures, confirming the unzipping of MWCNTs and the formation of GONRs. Even though the oxidation of graphene-like structures adds beneficial oxygen-based functional groups, excessive oxidation disrupts the x-system conjugation, reducing its conductivity. The XRD pattern of the Fe-MOFs in FIG. 2A shows crystalline structure peaks closely resembling the simulated diffraction pattern reported before, proving that the Fe-MOFs were successfully developed under the reported synthesis condition in this work. In the GONRs/Fe-MOFs composite, all the diffraction peaks matched those of Fe-MOFs, except for the disappearance of the two peaks at 18° and 22.5°, indicating that introducing GONRs into the Fe-MOFs crystal structure altered its defect pattern. The ultrasonic waves used during the physical mixing process of the composite's pure components may facilitate the interactions between Fe-MOFs and GONRs, forming chemical bonds between the oxygenated functional groups of GONRs and the vacancies in the Fe-MOFs structure. Notably, the characteristic diffraction peaks of GONRs are not discernible in the XRD patterns of GONRs/Fe-MOFs, primarily due to the lower intensities of carbon signals than those of Fe-MOFs. However, the patterns of Fe-MOFs are still presented in the composite.

The FT-IR spectra of the synthesized GONRs, Fe-MOFs, and GONRs/Fe-MOFs composite elucidate the nature and chemical bonding of the functional groups, allowing for a comprehensive examination of the materials' molecular structures. As illustrated in FIG. 3B, a strong band observed between 3600-3100 cm⁻¹ corresponds to the stretching mode of the O—H bond from intermolecular hydrogen bonding and/or adsorbed water. Additionally, a band at 1700 cm⁻¹ is associated with the O—H stretching in-COOH, which shifts to a higher wavenumber in M-OH. These bands were observed in all synthesized materials. Bands between 1000 cm⁻¹ and 1600 cm⁻¹ might correspond to various groups such as v (C—O), δ/β (O—H or C—OH), vₐₛ (C—O—C), and surface oxygen in metal oxides[34], with bands at 2360 and 2340 cm⁻¹ related to the P/R branches of v(O═C═O) [35], indicating an oxygenated surface typical of graphene oxide-like materials and Fe-MOFs. In addition to the previously mentioned bands, the FT-IR spectrum of GONRs, depicted in FIG. 3B, shows a band at 2930 corresponding to the v (C—H) in the CH2 group, a band at 2860 cm⁻¹ related to the Vas (C—H) in the CH₂ or CH₃ groups, and a band at 1650 cm⁻¹ related to the 8 (O—H) in the C—OH group, or C—O/C—O—C stretching consistent with reported spectrum of a graphene oxide-like structure. Additionally, a band at 630 cm⁻¹, most probably related to the v(C—S) in the C—SO₃H group, appeared due to the use of H₂SO₄ for the oxidative unzipping of the MWCNTs. The spectra of the Fe-MOFs, which were synthesized using benzene-1,4-dicarboxylic acid as organic ligands, provide evidence of an organic linker (benzene carboxylates) within the sample structure. Strong bands between 1600 cm⁻¹ and 1300 cm⁻¹ are attributed to symmetric and asymmetric vibration of a carboxyl group (—COO—) [38], along with the vibrational mode of C—C, respectively. Prominent bands between 600-1000 cm⁻¹ are associated with v (C—H) and the Fe—OH vibration bonding, while a peak at 550 cm⁻¹ corresponds to Fe—O vibrations. Bands between 600-1000 cm⁻¹ correspond to v (C—H) and Fe—OH vibrations, while the band at 550 cm⁻¹ is linked to Fe—O vibrations. These results align with previously reported data, confirming the formation of Fe-based MOFs[41]. The FTIR spectrum of the GONRs/Fe-MOFs composite shows a combination of the characteristic bands of both GONRs and Fe-MOFs spectra, with a significant increase in the intensity of the bands at 2360 cm⁻¹, 2340 cm⁻¹, and 617 cm⁻¹ upon the addition of GONRs, indicating the successful attachment of Fe-MOFs to the surface of GONRs, while other bands were significantly reduced. The Fe-MOFs characteristic bands were seen in the GONRs/Fe-MOFs composite spectrum, indicating that Fe-MOFs' structure remained prominent and preserved in the GONRs/Fe-MOFs composite. XRD and FT-IR results indicate the absence of any byproducts in the synthesized materials.

The TGA were performed to highlight the effect of GONRs on the thermal stability of Fe-MOFs. Below 100° C., the minor weight loss observed across all samples corresponds to the evaporation of physisorbed water molecules. For GONRs, a mass loss (8%) occurs between 100-250° C., which is characteristic of the thermal decomposition of labile oxygen-functional groups (e.g., carboxyl, epoxy, and hydroxyl groups). In contrast, the Fe-MOFs exhibits higher thermal degradation than GONRs, undergoing a two-stage decomposition process due to the progressive breakdown of its organic framework. The first stage (~200-300° C.) likely corresponds to ligand detachment, while the second (~350-450° C.) involves complete structural collapse.

Notably, the GONRs/Fe-MOFs composite demonstrates enhanced thermal stability compared to the pristine Fe-MOFs, attributed to coordination interactions between GONRs and the MOF's polymorphic structure. This stabilization mechanism indicates that graphene derivatives can act as reinforcing scaffolds, improving the thermal and mechanical resilience of MOFs. Further studies suggest that graphene-MOF hybridization not only delays thermal degradation but also enhances chemical stability, making such composites viable for harsh-environment applications (e.g., catalysis, energy storage).

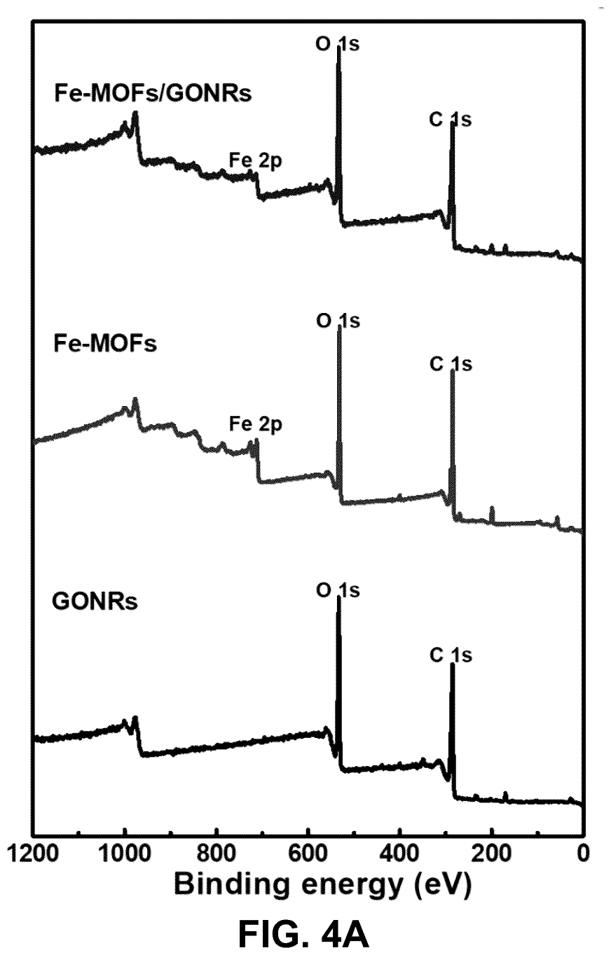

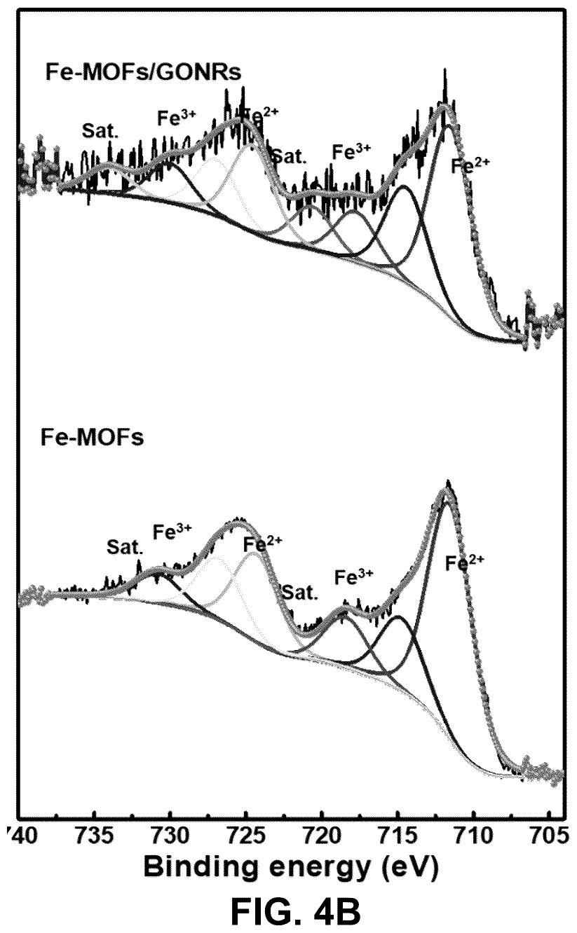

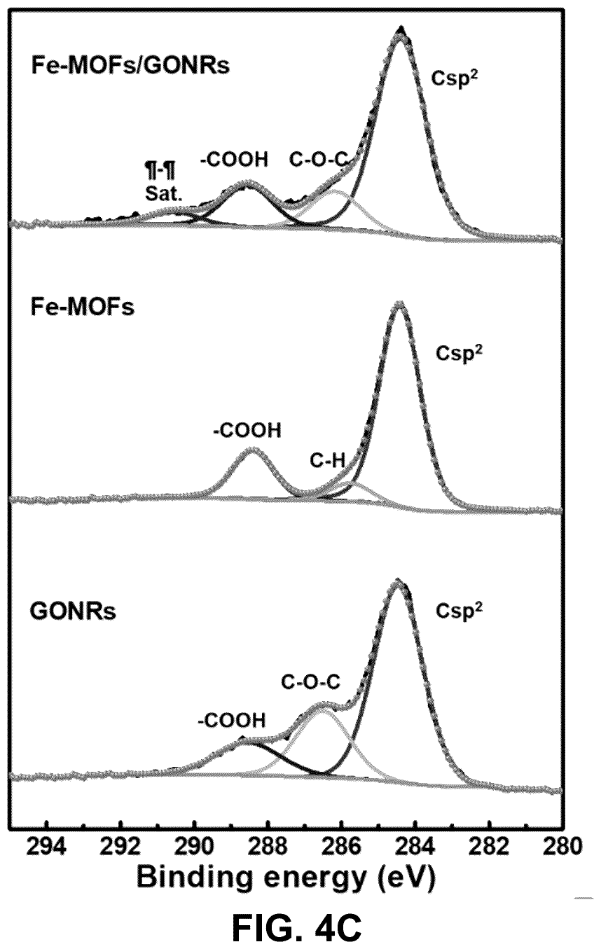

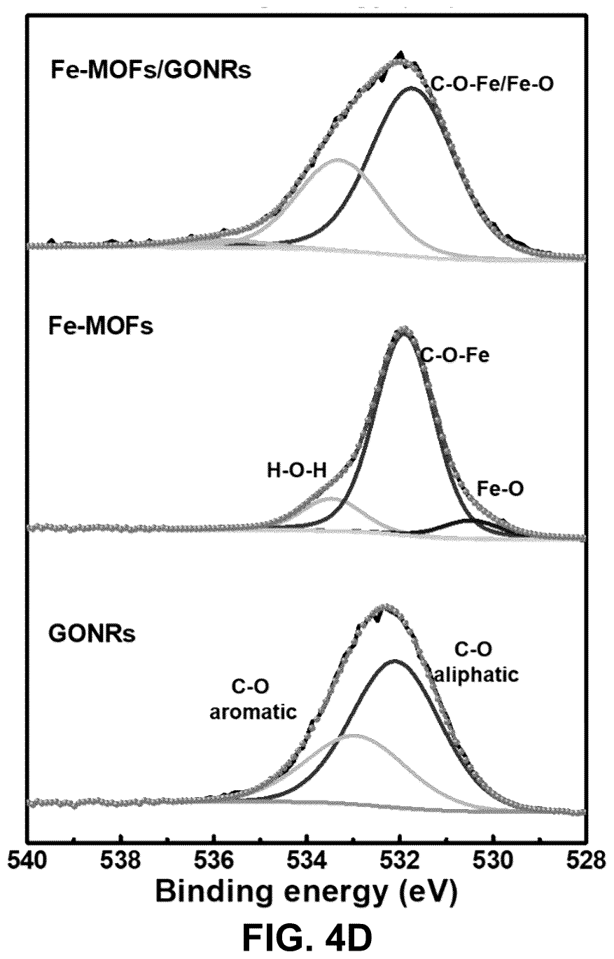

XPS analysis was employed to evaluate the nature of the chemical composition of the prepared Fe-MOFs and GONRs and gain a deeper understanding of the changes that occurred when they were combined. FIG. 4A shows the full XPS spectra of the GONRs, Fe-MOFs, and GONRs/Fe-MOFs samples with a fast scan. The XPS spectrum of the GONRs/Fe-MOFs composite showed similar peaks to those in GONRs (O 1s and C 1s) and Fe-MOFs (Fe 2p, O 1s, and C 1s), indicating the presence of Fe, O, and C elements in the GONRs/Fe-MOFs composite and affirming the successful combination of the of Fe-MOFs with GONRs.

FIG. 4B elucidates the high-resolution Fe 2p spectra of Fe-MOFs and GONRs/Fe-MOFs, observing two peaks at 711.0 and 725.0 eV corresponding to Fe 2p3/2 and Fe 2p1/2, which were validated by their binding energy difference of 14 eV. The Fe 2p3/2 and Fe 2p1/2 peaks were fitted to several peaks related to a different Fe oxidation state (Fe²⁺ and Fe³⁺). The peaks centered at 718.0 and 730.0 eV can be indexed to the satellite peak of Fe. The XPS spectrum of Fe 2p in the GONRs/Fe-MOFs composite was very similar to that of the Fe-MOFs alone, except that the satellite peak was divided and resolved into two separate peaks. This splitting occurs because the interaction between GONRs and Fe-MOFs introduces additional electronic states, resulting in peak separation. Additionally, there was a notable increase in the Fe³⁺ peak area. This increase in Fe³⁺ in the Fe-MOFs after integration with GONRs is attributed to the Fe bonding with the C—O functional groups of the GONRs. Since Fe³⁺ and Fe²⁺ have different electron densities, the coexistence of both enhances the electrical conductivity of the Fe-MOFs by facilitating electron transfer through Fe³⁺—O—Fe²⁺ interactions.

The fitted Cls spectrum for GONRs, in FIG. 4C, shows three peaks for hybridized carbon (Cₛₚ₂) at a binding energy of 284.5 eV and oxygenated carbon (C—O—C) and (—COOH) at binding energies of 286.5 eV and 288.5 eV, respectively. This reveals the enrichment of GONRs with oxygenated functional groups, which is expected to significantly enhance the hydrophilicity and wettability of the GONRs and the GONRs/Fe-MOFs composite. For Fe-MOFs, the C1s spectrum deconvoluted into three peaks of binding energy 284.5, 285.7, and 288.5 eV indicate the presence of C—C, C—H, and C═O, respectively. In the GONRs/Fe-MOFs composite, the intensity of the C—O—C peak was decreased compared to the —COOH peak, as an indication of the interaction of Fe-MOFs with oxygenated (C—O—C) sites and formation of chemical bonding between the Fe-MOFs and GONRs, where a partial migration of the peripheral electrons happens from the C—O—C site to the M-O site.

The O1s spectrum of GONRs was deconvoluted to two peaks for C═O aliphatic and C—O aromatic at 532.1 eV and 533 eV, respectively, as shown in FIG. 4D. For Fe-MOFs, the Ols spectrum was found to consist of three peaks related to lattice oxygen (M-O-M) at 530.2 eV, oxygen vacancies (Fe—O) at ~532 eV, and the oxygen of the surface adsorbed water (H—O—H) at ~533.3 eV. The Fe-MOF/GONRs composite shows the same deconvolution spectrum as the GONRs. However, the contribution of the C—O—Fe/Fe—O was significantly increased as an indication of the strong chemical interaction between Fe-MOFs and GONRs oxygenated functional groups.

### Electrochemical Evaluation and Supercapacitors Efficiency

### Effect of GONRs on Fe-MOFs Supercapacitive Performance and Stability

Electrochemical tests were performed using various aqueous electrolytes, including 1M H₂SO₄, 1M KOH, and nearly saturated (~0.7M) K₂SO₄ solutions, to evaluate the supercapacitive performance of the Fe-MOFs and GONRs/Fe-MOFs composite electrode materials. The invention aimed to explore the effects of different anions and cations in these electrolytes on electrochemical properties and overall supercapacitive performance. The invention, for that purpose, utilized cyclic voltammetry (CV), galvanostatic charging/discharging (GCD) tests, and electrochemical impedance spectroscopy (EIS) using a three- and two-electrode setup.

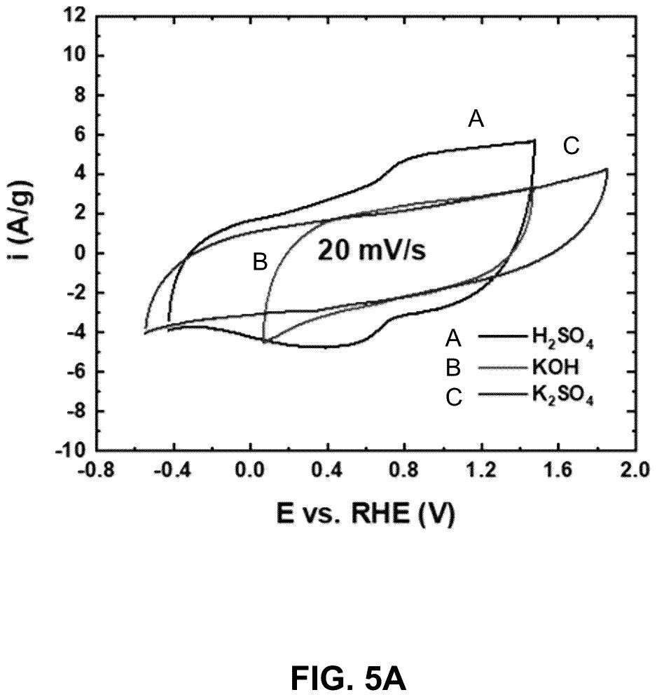

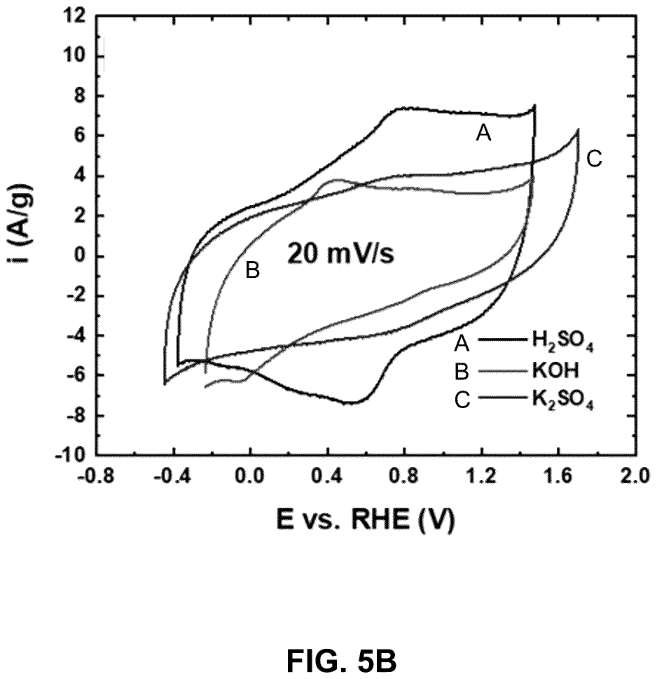

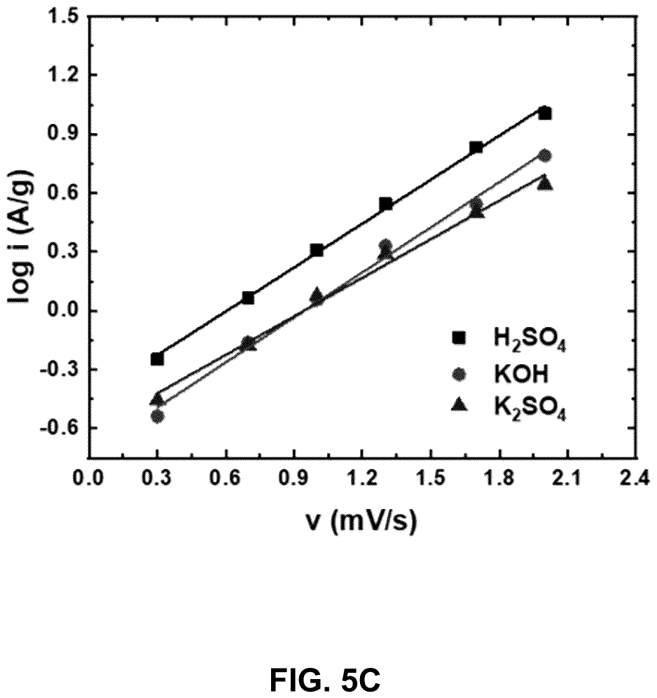

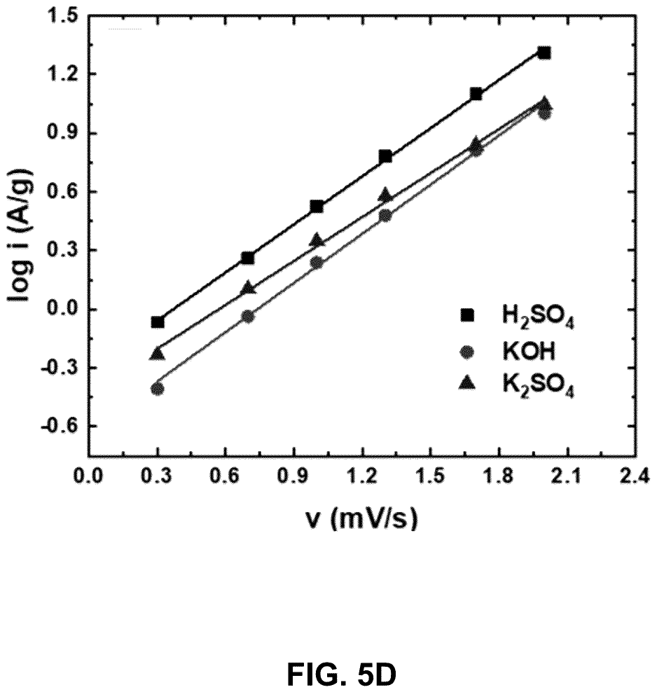

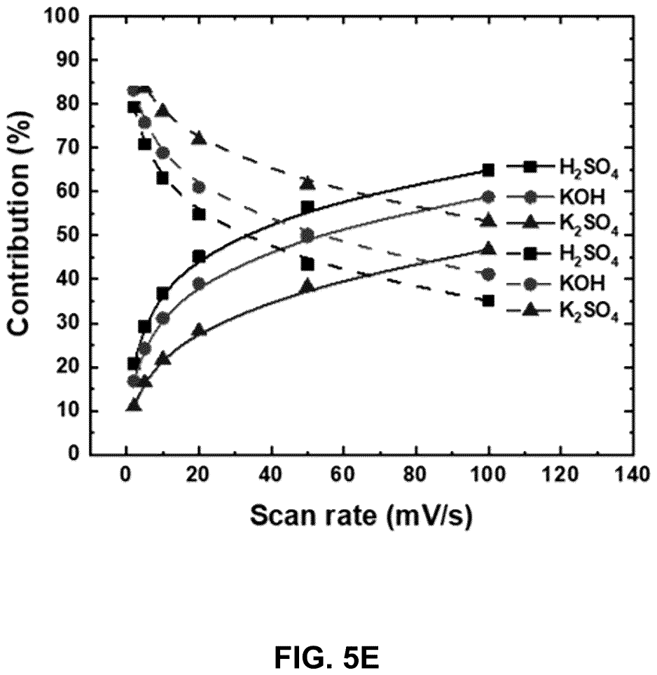

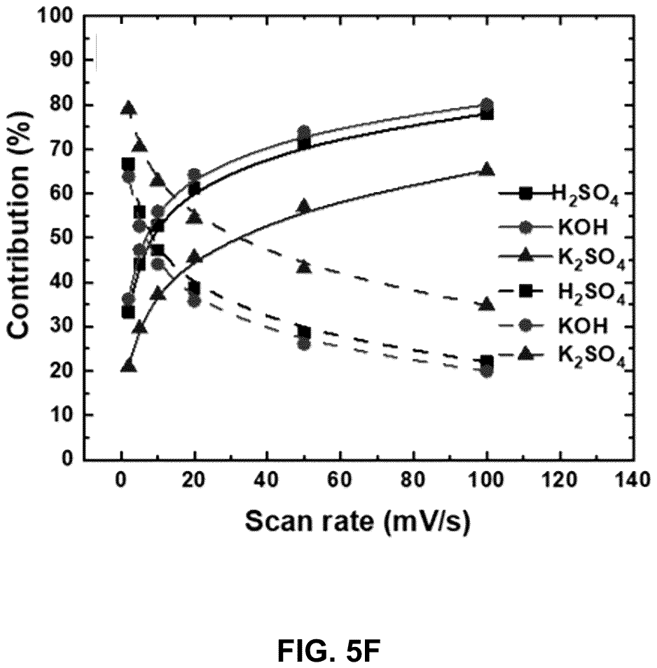

The CVs of the Fe-MOFs displayed different shapes depending on the electrolyte used, as illustrated in FIG. 5A, indicating different contributions from supercapacitive mechanisms (EDLC vs. pseudocapacitance) in the overall performance. The behavior of the Fe-MOFs is likely affected by the protonation/deprotonation of C—O—H/C—O groups and changes in the oxidation state of the Fe centers within the Fe-MOFs. At a scan rate of 20 mV/s, CVs in 1 M H₂SO₄ revealed clear pseudocapacitive peaks. In contrast, the CVs in 1 M KOH and approximately 0.7 M K₂SO₄ primarily showed an EDLC mechanism characterized by a rectangular shape. This suggests that the proton concentration strongly influences pseudocapacitive behavior, mainly through the protonation/deprotonation of C—O—H/C═O groups.

Additionally, the potential window was pH-dependent, with the neutral solution showing an exceptional potential window of 2.4 V, followed by that in the acidic solution (1.9 V) and the alkaline solution (1.4 V). In contrast, all the CVs (20 mV/s) of GONRs/Fe-MOFs exhibited pseudocapacitance peaks associated with the oxidation and reduction of the oxygenated functional groups on GONRs, highlighting a substantial contribution of the GONRs pseudocapacitive mechanism to the overall supercapacitive performance.

A significantly larger capacitive area was observed for the GONRs/Fe-MOFs composite than for Fe-MOFs alone (FIG. 5B), with pH-dependent potential window values similar to those observed for the Fe-MOFs alone. This indicates the crucial role of GONRs in enhancing the capacitive performance of the GONRs/Fe-MOFs composite. This improved performance can be attributed to the high capacitance of GONRs, resulting from the interaction between the oxygenated groups on GONRs and H⁺ ions in the solution, as well as the strong interaction of these groups with Fe-MOFs, as suggested by XPS results. These interactions enhanced conductivity and capacity in the GONRs/Fe-MOFs composite. To substantiate these observations, CVs for Fe-MOFs and GONRs/Fe-MOFs composite in all electrolytes at scan rates ranging from 2-100 mV/s. The ability of all CVs to maintain their shapes at a high scan rate of 100 mV/s suggests excellent charging and discharging capabilities. This CV data were used to calculate the electric double-layer capacitance (Cdi) that is directly proportional to the ECSA, which is a better measure of the electrolyte accessibility. The Cal values, determined from the slope of the I/v linear relationship as explained in the experimental section. These results reveal that the GONRs/Fe-MOFs exhibit the largest ECSA in H₂SO₄ (562 m²/g) compared to other electrolytes, KOH (219 m²/g) and K₂SO₄ (437 m²/g), suggesting a greater accessibility of the electrochemically active sites in H₂SO₄ over the other electrolyte, due to its unique ion dynamics. Upon dissociation, H₂SO₄ generates highly mobile H⁺ ions, which are significantly smaller than K⁺. This compact size allows protons to penetrate deeper into the electrode's porous structure, enhancing electrolyte dragging and hence wettability. As a result, the electrolyte infiltrates micropores more effectively, maximizing the accessible active area for charge storage. While K₂SO₄ dissociates into 2K⁺ and SO₄²⁻, where the sulfate ion (SO₄²⁻) possesses a di-negative charge, whereas KOH dissociates into K⁺ and OH, with the hydroxide ion (OH) carrying only a one negative charge.

The higher charge of SO₄²⁻ results in stronger electrostatic interactions with material surface, promoting greater ion adsorption and enhancing the ECSA compared to OH⁻. Thus, the divalent nature of SO₄²⁻ in K₂SO₄ facilitates stronger interfacial interactions and more effective charge transfer, making it a more electrochemically active electrolyte than KOH. This difference explains why H₂SO₄ consistently outperforms KOH and K₂SO₄ in enhancing ECSA. and overall capacitive performance.

CV data for the GONRs/Fe-MOFs composite in 1M K₂SO₄ were also conducted at higher scan rates (up to 500 mV/s). Remarkably, the CV curves maintained their shape without significant distortion, highlighting the composite's exceptional fast charging/discharging performance.

Power law (Equation 7) was employed to better understand the relative contributions of bulk (diffusion-controlled capacitance) and surface (non-diffusion-controlled capacitance) to the ion diffusion kinetics and, consequently, energy storage capacity. FIGS. 5C-5D show the relationship between the log I vs. log v for Fe-MOFs and GONRs/Fe-MOFs composite, respectively.

$$log I ( V ) = a + b log ( ν ) \qquad ( 7 )$$

Here, I (V) represents the potential-dependent anodic current value at 0.1 V vs. RHE at a given scan rate (v), while a and b are adjustable parameters, with b being the slope and a the intercept. The b value is crucial in understanding the charge storage mechanism, as a b value close to 0.5 indicates a diffusion-controlled storage mechanism, and a value close to 1 suggests a non-diffusion-controlled storage EDLC mechanism essential for achieving a high power density. A linear log I vs. log v relationship was observed in all cases, indicating that the supercapacitive behavior of the testing materials follows the power-law relationship. The GONRs/Fe-MOFs composite exhibited b values higher than Fe-MOFs in all the electrolytes. In 1 M H₂SO₄, 1 M KOH, and ~0.7M K₂SO₄ electrolytes, the GONRs/Fe-MOFs composite exhibited b values of 0.82, 0.84, and 0.75, respectively, while b values of 0.74, 76, and 0.68 were observed for Fe-MOFs. These values suggest that the capacitative behavior in acidic and alkaline electrolytes is more surface-dominant with lower diffusion limitations than in neutral electrolytes. This difference is likely related to the size of the electrolyte ions, with the H⁺ and OH-ions in acidic and alkaline solutions being smaller and diffusing faster than the larger K⁺ ions in neutral solutions. The higher slope values observed for the GONRs/Fe-MOFs composite indicate that incorporating GONRs enhances the non-diffusion-controlled storage mechanism characteristic of EDLC, which is essential for achieving higher power density.

FIGS. 5E-5F illustrate the contribution (%) of non-diffusion-controlled and diffusion-controlled charge storage mechanisms for the Fe-MOFs and GONRs/Fe-MOFs composite. At low scan rates, the diffusion-controlled (bulk) process contribution was predominant in all electrolytes as a charge storage mechanism for both the Fe-MOFs and GONRs/Fe-MOFs composite. However, this contribution decreased significantly with increasing scan rates, and the non-diffusion-limited (surface) capacitive response increased. In 1 M H₂SO₄, 1 M KOH, and ~0.7M K₂SO₄ solutions, at slow scan rates, the bulk contribution of Fe-MOFs and GONRs/Fe-MOFs composite accounted for 80% and 68%, 85% and 65%, and 90% and 80% of their capacitance, respectively, and dropped to 42% and 25%, 45% and 20%, and 55%, and 32% at 100 mV/s at 100 mV/s. The charging process was hindered at fast scan rates as ions couldn't diffuse quickly enough into the layers, unlike lower scan rates, which allowed better access of the ions to interlayer regions as they had sufficient time to reach these regions. As can be seen from this analysis, across the different scan rates, the GONRs/Fe-MOFs composite exhibits the lowest diffusion-limited bulk contribution (%) and a higher non-diffusion-limited surface contribution compared to Fe-MOFs, which can be attributed to the ability of the electrolyte in the GONRs/Fe-MOFs composite to penetrate deeper into the bulk layers, causing more of the bulk to behave as a surface, resulting in increased capacitance. In addition, the non-diffusion-limited surface contribution is higher in the case of 1 M H₂SO₄ and 1 M KOH solution than ~0.7 M K₂SO₄ solution, suggesting improved kinetics and a higher ions' ability to access the interlayer regions due to the more rapid diffusion of the smaller ions in various electrolytes diffuse than the large ones.

The size of ions and swelling effects are critical factors that significantly influence the capacitance mechanism in supercapacitors. These effects are closely tied to how electrolytes interact with the electrode materials, particularly in materials like graphene oxide (GOx) and metal-organic frameworks (MOFs). Several studies have explored the impact of different electrolytes on the supercapacitive performance of these materials, providing insights into the underlying mechanisms. For instance, in acidic conditions, research by A. V. It has been demonstrated that the d-spacing (the distance between layers) of GOx decreases compared to its spacing in pure water. This reduction in d-spacing is attributed to the protonation of functional groups on GOx, which leads to a contraction of the material's structure. However, this contraction is less pronounced in acidic conditions than in the presence of salts like NaCl and Na₂SO₄. In salt solutions, larger cations (Na⁺) and anions (Cl⁻, SO₄²⁻) further reduce the d-spacing due to stronger electrostatic interactions and ion intercalation, significantly compressing the GOx layers. On the other hand, in alkaline conditions, the presence of OH ions induces a swelling effect in GOx. This swelling results in a notable increase in d-spacing compared to acidic conditions and pure water. The OH ions interact with the oxygenated functional groups on GOx, causing electrostatic repulsion between the layers and expanding the material. This swelling effect enhances the accessibility of ions to the interlayer regions, which can improve ion diffusion and capacitive performance. Therefore, optimizing the electrolyte composition and understanding its interaction with the electrode materials are crucial for achieving high-performance supercapacitors.

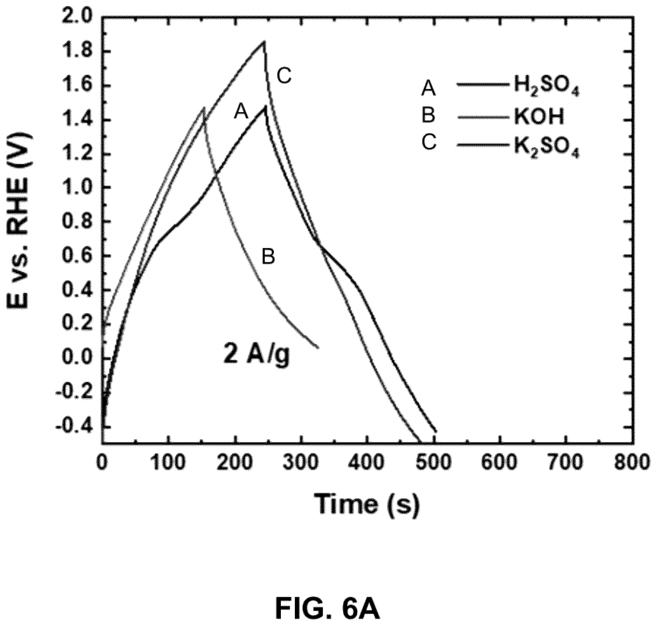

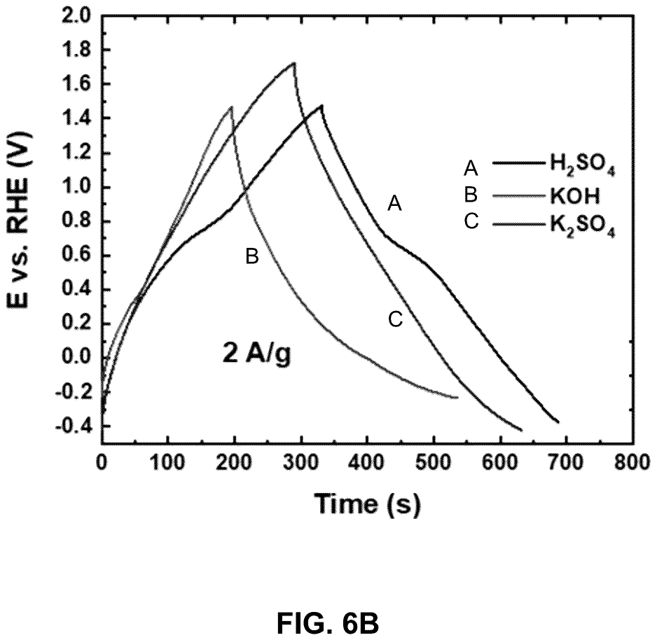

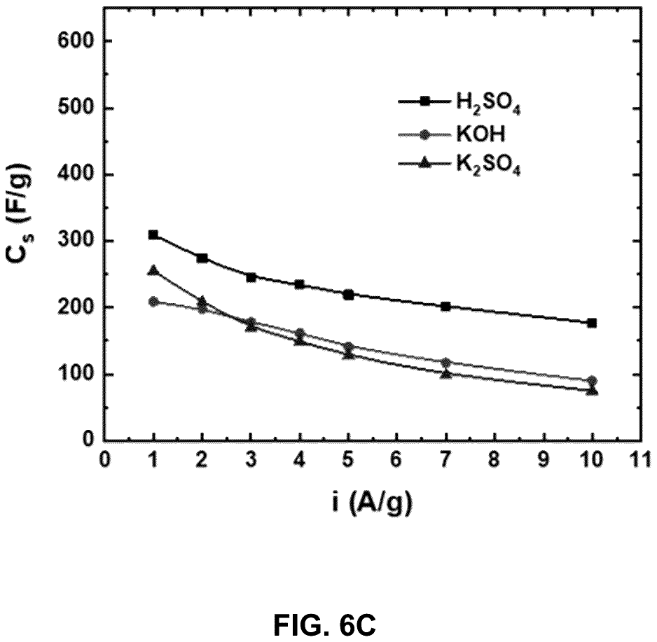

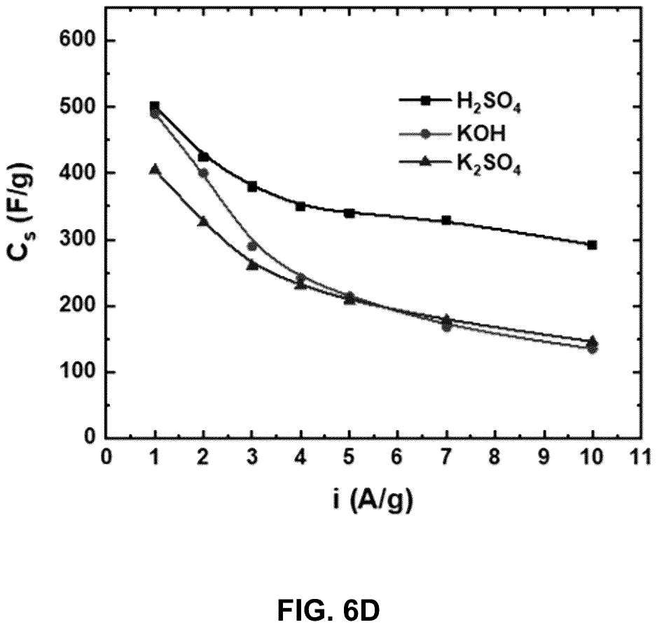

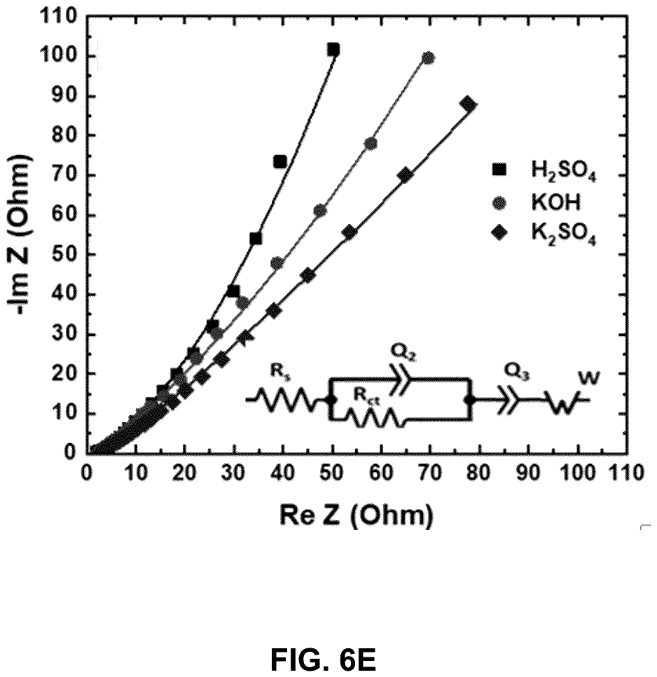

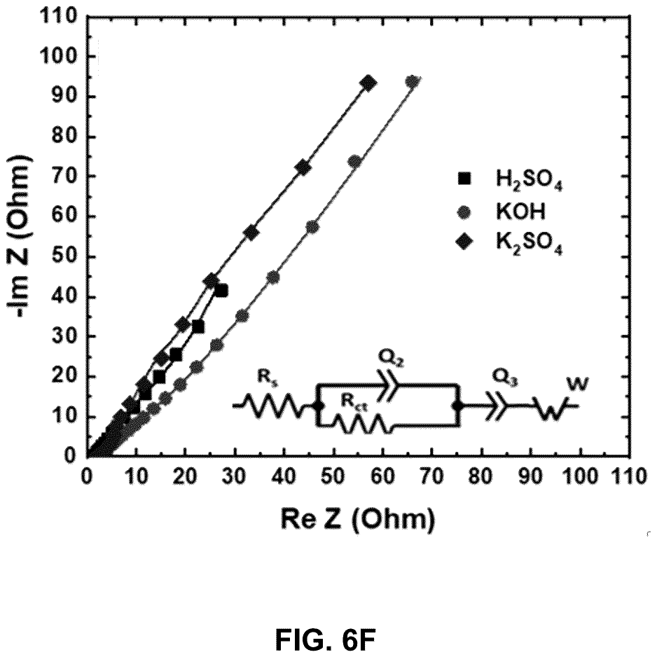

GCD measurements were performed to evaluate further analysis of the supercapacitor performance for Fe-MOFs and GONRs/Fe-MOFs composite. FIGS. 6A-6B illustrate their GCD responses in 1 M H₂SO₄, 1 M KOH, and (~0.7M) K₂SO₄ electrolytes at a constant charge/discharge current density of 1 A/g, while (not shown) the GCD responses at varying current densities (1-10 A/g). The GCD curves exhibited a quasi-triangular shape, reflecting the material's high electrical conductivity and low IR drop, facilitating rapid charge transfer. In 1 M H₂SO₄, the GCD curves showed a nearly constant potential change rate and a prolonged discharge time, highlighting EDLC characteristics and indicating strong energy efficiency and capacity. As seen in earlier CV results, the shift in the potential change rate within the 0.4-0.8 V vs. RHE range is associated with pseudocapacitive behavior. This behavior is attributed to oxygenated functional groups on the surface and is more prominent in acidic electrolytes due to the high proton concentration, which enhances protonation/deprotonation processes. In neutral K₂SO₄ electrolytes, the GCD curves maintained a quasi-triangular shape with consistent potential changes during both the charging and discharging phases, suggesting dominant EDLC behavior and high-power performance. In contrast, the GCD curve for KOH displayed an inconsistent potential drop rate during discharge, indicating lower energy efficiency.

The potential window of any material depends on its ability to catalyze water electrolysis and the range in which the columbic efficiency of GCD measurements is as close as possible to 100%. In another study by the inventors on the supercapacitance behavior of GONRs at different pHs, only a potential window of 1.5-1.7 V was observed, with K₂SO₄ (the neutral media) showing the widest potential window. Therefore, the ultrawide potential window of the GONRs/Fe-MOFs composite should be related to the presence of the Fe-MOFs, which exhibited a potential window very similar to that of the composite. Additionally, combining Fe-MOFs with GONRs reduces the GONRs' ability to catalyze the water electrolysis (HER or OER). Accordingly, the role of GONRs in the GONRs/Fe-MOFs composite behavior is mainly to enhance the Fe-MOFs conductivity, improve charge transfer kinetics, and increase the surface area, allowing for enhanced capacitive behavior with no significant effect on the potential window.

The Fe-MOFs electrode in H₂SO₄, KOH, and K₂SO₄ exhibited a specific capacitance of 308, 210, and 256 F/g, respectively, compared to 502, 493, and 403 F/g for the GONRs/Fe-MOFs composite electrode as depicted in FIGS. 6C-6D, indicating an overall improvement in the supercapacitive behavior in all electrolytes, which could be due to the inherited high capacitance of the GONRs and the enhancement of the Fe-MOFs supercapacitive performance through interaction with GONRs. Furthermore, as discussed earlier, the nature of electrolytes significantly affects the supercapacitive performance of the Fe-MOFs and the GONRs/Fe-MOFs composite. The acidic electrolyte is the best in terms of overall capacitance at all current densities due to the high contribution of the pseudocapacitance and the H⁺ ion's small size and extraordinary mobility and ionic conductivity mechanism. In the absence of GONRs, Fe-MOs showed similar capacitance at all currents in the neutral and alkaline media. However, in the presence of GONRs, the GONRs/Fe-MOFs composite showed high capacitance in the alkaline solution at low currents, similar to that of the acidic media, and low capacitance at high currents, comparable to neutral solutions. The special swilling of GONRs in alkaline media facilitates the approach of the electrode bulk and, hence, high capacitance. However, that is insufficient to facilitate ions mobility as the current value increases.

FIGS. 6E-6F present the Nyquist plots of the EIS analysis conducted for Fe-MOFs and the GONRs/Fe-MOFs composite at open circuit potential (OCP) using a three-electrode system, utilizing different electrolytes. The equivalent circuit used for fitting the EIS data, considering both pseudo capacitance (PC) and electrical double layer capacitance (EDLC), is shown in the inset of FIGS. 6E-6F. This equivalent circuit comprises the following components: Rₛ (series resistance of the electrolyte and contacts), Ret (charge transfer resistance), and Q₂/Q₃ (constant phase elements) corresponding to pseudo capacitance (PC) related to redox reactions and EDLC, respectively, as well as W (Warburg element), which is associated with diffusion limitations. The EIS fitting results for the Fe-MOFs and GONRs/Fe-MOFs composites are presented in Table 1. The steepness of the EIS response at low frequencies indicates diffusion limitations, known as the Warburg impedance, which results from the frequency-dependent ion diffusion at the electrode-electrolyte interface[63]. A slope of 1 indicates a fully diffusion-controlled supercapacitance, while higher slopes suggest reduced diffusion limitation. The Nyquist plot slopes for Fe-MOFs vary significantly across different electrolytes (FIG. 6E), with values of 2.8, 1.9, and 1.28 in H₂SO₄, KOH, and K₂SO₄, respectively. This highlights the strong influence of electrolyte type on diffusion-controlled supercapacitance, with neutral electrolytes showing the smallest slope value, indicating a more significant contribution of diffusion control compared to acidic and alkaline electrolytes. After compositing Fe-MOFs with GONRs (FIG. 6F), the slope values for the composite become more similar, at 1.64, 1.73, and 1.57 in H₂SO₄, KOH, and K₂SO₄, respectively, indicating a reduced role of diffusion control due to the addition of GONRs, which facilitate the diffusion of ions due to its high content of oxygenated functional groups and hence high hydrophilicity. Since EIS measurements were performed at OCP, ions were already at the electrode-electrolyte interface, moving over short distances. Due to their reduced movement during discharge, ions with higher charge and smaller hydration layers may face less significant diffusion barriers during charging.

TABLE 1
EIS fitting values for Fe-MOFs and GONRs/Fe-MOFs composite in
1M H₂SO₄, 1M KOH, and saturated solution (≈0.7M) of K₂SO₄.

| Electrode | | Rct (PC) | Q₂ (PC) | Q₃ (EDLC) | W |
|---|---|---|---|---|---|
| material | Electrolyte | (Ohm) | (mF · s^{(a-1)}) | (mF · s^{(a-1)}) | (Ohm · s^{-1/2}) |
| Fe-MOFs | H₂SO₄ | 1.9 ± 0.02 | 0.018 ± 0.001 | 0.207 ± 0.006 | 12.7 ± 0.07 |
| | KOH | 2.9 ± 0.009 | 0.013 ± 0.0003 | 0.047 ± 0.02 | 15.6 ± 0.13 |
| | K₂SO₄ | 2.88 ± 0.01 | 0.0034 ± 0.005 | 0.038 ± 0.02 | 34.01 ± 0.0 |
| GONRs/ | H₂SO₄ | 1.25 ± 0.02 | 0.565 ± 0.024 | 0.513 ± 0.04 | 3.938 ± 0.14 |
| Fe-MOFs | KOH | 2.3 ± 0.006 | 0.108 ± 0.003 | 0.195 ± 0.006 | 11.94 ± 0.1 |
| | K₂SO₄ | 1.84 ± 0.009 | 0.063 ± 0.0004 | 0.04 ± 0.005 | 27.8 ± 0.003 |

Table 1 shows that the Q₃ (EDLC) values follow H₂SO₄>KOH>K₂SO₄ for both Fe-MOFs and the GONRs/Fe-MOFs composite. The significant increase in Q₃ for H₂SO₄ suggests improved capacitive performance, as H⁺ ions can penetrate deeper into the electrode material, providing greater access to the bulk. A Warburg element in the EIS indicates an energy storage mechanism limited by ion diffusion within the electrode bulk. The Warburg diffusion resistance (W) follows the H₂SO₄<KOH <K₂SO₄ order, indicating that H₂SO₄ has the lowest ion-diffusion resistance and thus offers better capacitive performance. The studies for this invention conclude that selecting appropriate electrolyte anions and cations is crucial for optimizing the supercapacitive performance of the GONRs/Fe-MOFs composite. Electrolytes with smaller ions, particularly those that facilitate intercalation and enhance conductivity, produce superior electrochemical performance. These insights can inform the design of high-performance supercapacitors with customized electrolytes for specific applications.

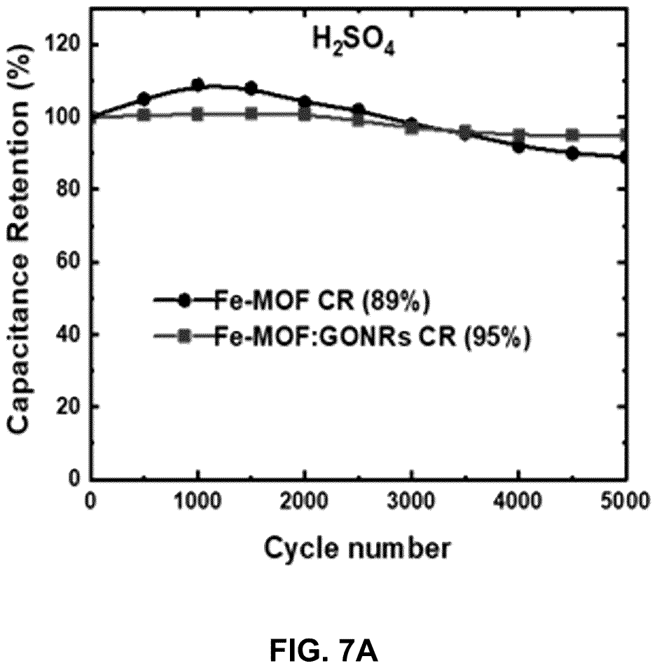

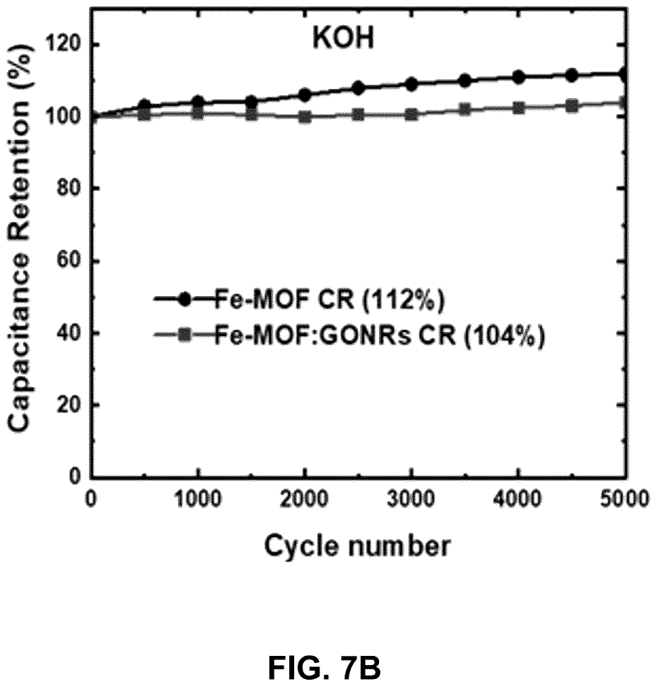

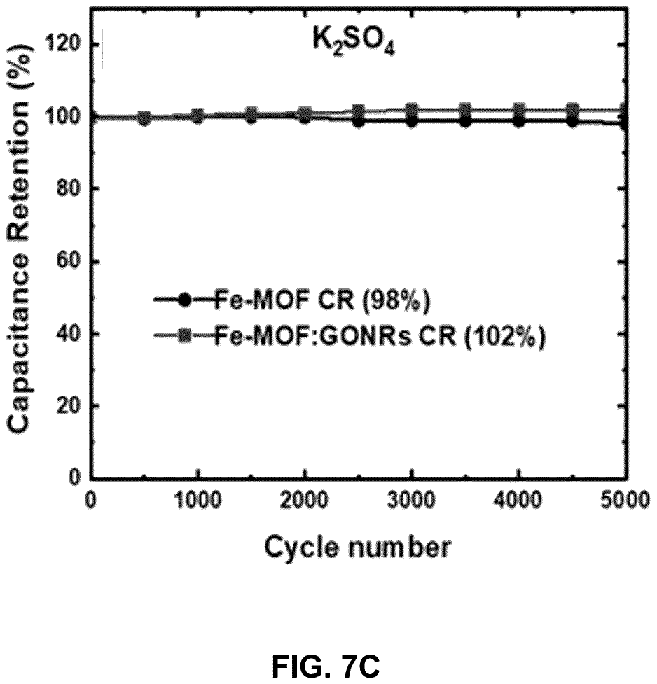

The stability of the electrodes in all the electrolyte solutions using the three-electrode setup was evaluated by performing GCD at a current density of 10 A/g for 5000 cycles, and the calculated capacitance retention (CR) is shown in FIGS. 7A-7C. For a 1 M H₂SO₄ electrolyte, the Fe-MOFs showed a CR increase to 108% after 1000 cycles (FIG. 7a), likely due to the forced insertion of ions inside the difficultly accessible pores of the MOFs during cycling [65] and then gradually decreased to about 89%. In contrast, after adding GONRs in the GONRs/Fe-MOFs composite, the electrode retained most of its capacitance for 5000 cycles, achieving ~95% CR, indicating the GONRs' role in stabilizing the Fe-MOFs in acidic media. For a 1 M KOH electrolyte, the Fe-MOFs and GONRs/Fe-MOFs composite showed CR increase to 112% and 104% after 5000 cycles, as shown in FIG. 7B. For the K₂SO₄ electrolyte (~0.7M), FIG. 7C shows that the Fe-MOFs maintained most of their capacitance with CR of 98% while slightly increasing to 102% for the GONRs/Fe-MOFs composite after 5000 cycles. These results indicate the high stability of the Fe-MOFs in the presence and absence of GONRs. Incorporating GONRs enhances the uniformity of the Fe-MOFs' capacitance value due to their high content of oxygenated functional groups that significantly improve wettability, allowing for uniform electrolyte penetration into the electrode layers.

To further confirm the stability of the Fe-MOFs in the presence and absence of GONRs after 5000 cycles in the different aqueous electrolytes, the ICP-OES measurements of spent electrolytes of Fe-MOFs and Fe-MOFs/GONRs after 5000 GCD cycles were performed. The determined Fe concentrations are presented in Table 2.

TABLE 2
The analysis results of the ICP test for Fe-MOFs and Fe-MOFs/GONRs
composite after three electrodes cycling (5000 cycles) in 1M H₂SO₄,
1M KOH, and saturated solution (≈0.7M) of K₂SO₄.

| Elec- | | |
|---|---|---|
| trolyte | Fe-MOFs | Fe-MOFs/GONRs |
| H₂SO₄ | 25.8 × 10⁻⁴ mg/l (1.1 × 10⁻²%) | 24.4 × 10⁻⁴ mg/l (1 × 10⁻²%) |
| KOH | 22.9 × 10⁻⁶ mg/l (1 × 10⁻⁴%) | 34 × 10⁻⁷ mg/l (1 × 10⁻⁵%) |
| K₂SO₄ | 21.3 × 10⁻⁸ mg/l (9 × 10⁻⁷%) | 59 × 10⁻⁹ mg/l (2.5 × 10⁻⁷%) |

The analysis reveals that only trace amounts of iron (Fe) ions were detected in the tested solutions, indicating the electrodes' excellent stability. The stability depends on pH, with the neutral media showing the highest stability, followed by the alkaline media, and then the acidic media. Notably, GONRs enhance the Fe-MOFs' stability, with that effect being less pronounced in acidic media. XPS analysis was conducted on the GONRs/Fe-MOFs composite before and after cycling to investigate whether the leached Fe affected the electrode. The full survey scans XPS spectra of the GONRs/Fe-MOFs composite before and after the stability test reveals no significant compositional changes, except for the appearance of an F 1s peak, which is attributed to the PVDF binder [66]. In the Fe 2p spectra, a minor shift to lower binding energy (~0.3-0.5 eV) occurs after cycling, likely due to Fe—F bond formation from PVDF interaction, which redistributes charge around Fe. The persistence of Fe signals confirms negligible leaching, consistent with the ICP results and the material's electrochemical stability. A slight modification was observed in the C 1s and O 1s spectra, indicating heightened oxygen-containing groups (e.g., C—O, O—C═O) attributed to surface oxidation during prolonged cycling. This oxidation enhances wettability and ion adsorption, potentially boosting pseudocapacitive behavior. Incorporating GONRs into the Fe-MOFs structure significantly improves the composite's supercapacitive performance.

Table 3 compares the energy storage performance of the GONRs/Fe-MOFs composite electrode in three-electrode systems to other active materials in the literature, demonstrating clear advantages over existing electrode materials. These findings emphasize the potential of GONRs/Fe-MOFs composite as a promising material for supercapacitor applications.

TABLE 3
Comparison of the three-electrode electrochemical performance
of Fe MOFs/GONRs composite with other pristine MOFs.

| | | Cycling | Specific | | |
|---|---|---|---|---|---|
| | | stability/ | capacitance | | |
| Electrode Material | Electrolyte | cycles | (F/g) | | Ref |
| Fe-MOF Nanorods | 3M KOH | 85%/5000 | 96@ 0.04 | A/g | others |
| Fe-doped Co-MOF | Ionic liquid (IL) | 93.8%/3000 | 319.5@ 1 | A/g | others |
| MIL-100 (Fe) | 0.1M Cs₂SO₄ | — | 62@ 1 | A/g | others |
| Hybrid Fe-MOF and derivative | Alkaline solution | — | 415.2@ 1 | A/g | others |
| Fe-MOFs/GONRs | 1M H₂SO₄ | 95%/5000 | 502@ 1 | A/g | This Work |
| Fe-MOFs/GONRs | 1M KOH | 104%/5000 | 493@ 1 | A/g | This Work |
| Fe-MOFs/GONRs | 0.7M K₂SO₄ | 102%/5000 | 403@ 1 | A/g | This Work |

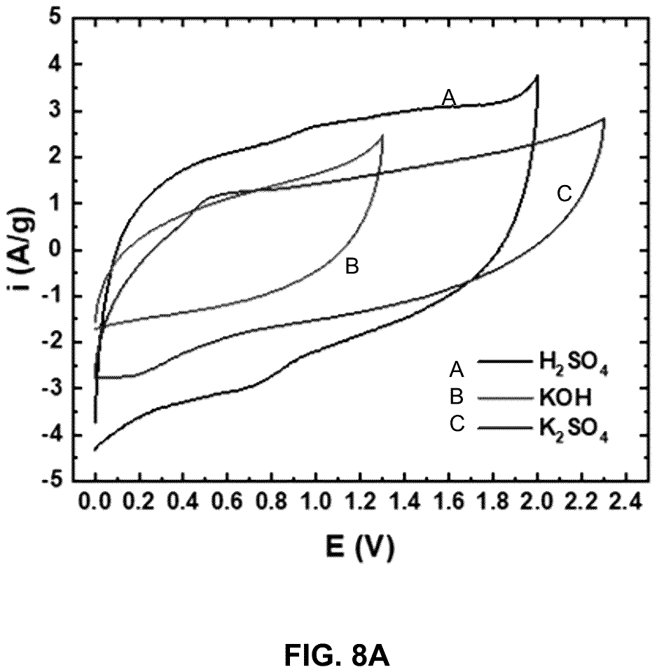

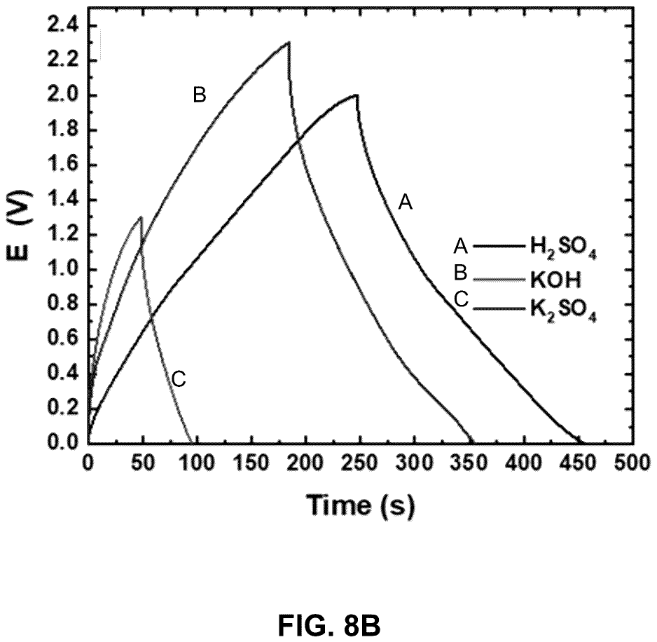

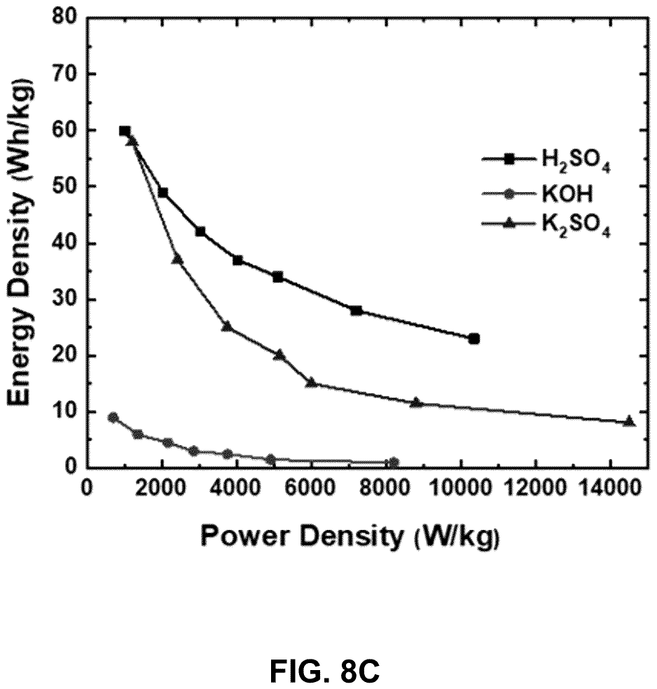

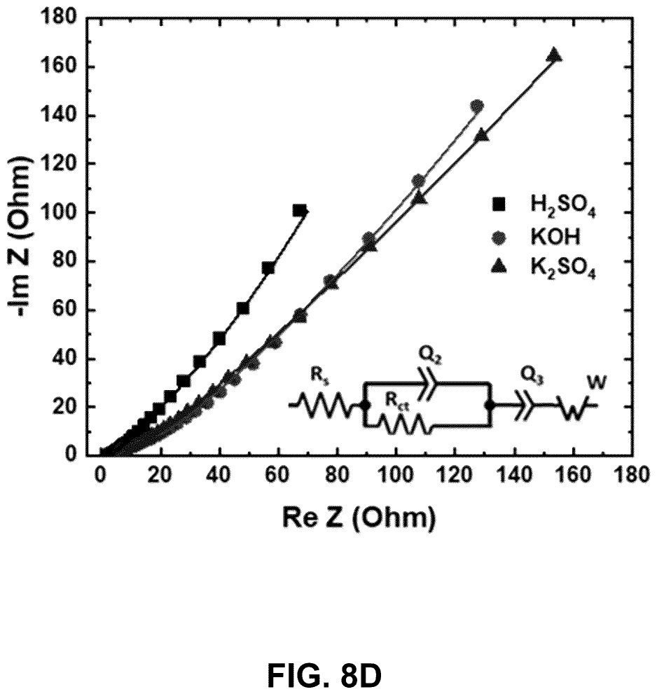

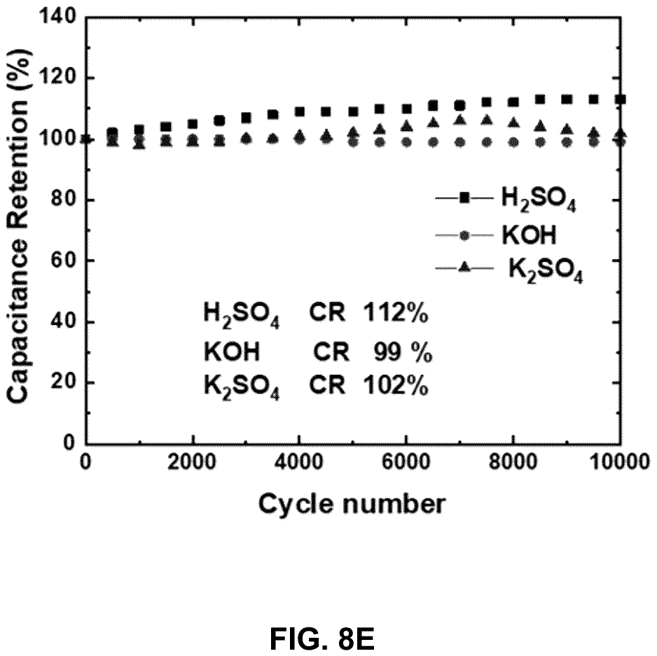

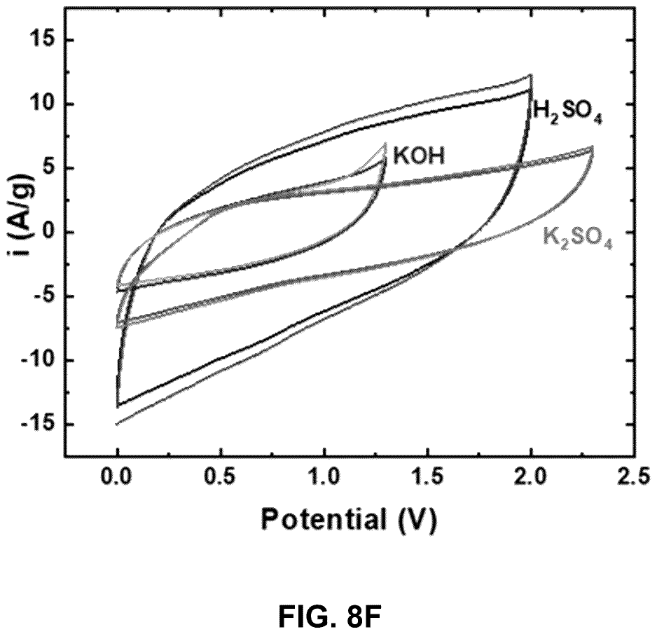

For practical application, GONRs/Fe-MOFs composite materials were evaluated as positive and negative electrodes for symmetric supercapacitors, using CV, GCD, and EIS electrochemical techniques in various electrolytes. The analysis and summary of these results are illustrated in FIGS. 8A-F. For comparison, FIG. 8A presents the CV curves at 20 mV/s; according to these CV responses, 1 M H₂SO₄ demonstrated the best capacitive performance, followed by neutral media, consistent with the CV curves reported in the three-electrode system. The CVs revealed a vast potential window in acidic and neutral media, reaching 2.3 V in 0.7 M K₂SO₄, an unprecedented ultrawide potential window in aqueous electrolytes. Thermodynamically, water electrolysis should occur at 1.23 V. However, hydrogen evolution reaction (HER) and oxygen evolution reaction (OER) require higher potential than the thermodynamic values (overpotential losses) due to kinetic barriers. The GONRs/Fe-MOFs electrode material showed a high overpotential for both HER and OER, suppressing undesired water decomposition within the investigated voltage range. For efficient HER, protons (H⁺) must be readily adsorbed onto active sites, and subsequent reactions should proceed with minimal energy barriers. However, the GONRs/Fe-MOFs composite surface is rich in oxygen-containing functional groups (—OH, —COOH), which reduced the HER kinetics. On the other hand, the neutral K₂SO₄ electrolyte plays a crucial role in extending the potential window. Unlike acidic or alkaline electrolytes, which facilitate rapid HER and OER kinetics, neutral solutions increase the overpotential due to the low concentration of H⁺ and OH-ions, allowing for a wider operational voltage range. Furthermore, the electrolyte's neutrality reduces side reactions and enhances long-term stability.

To further validate these findings, it was found that the CV curves of the GONRs/Fe-MOFs showed symmetric supercapacitor across various potential windows, with an upper limit up to 2.7 V, at a scan rate of 20 mV/s in 0.7 M K₂SO₄ electrolyte. The CV curves within the 0 to 2.3 V range were nearly rectangular, indicating highly reversible double-layer capacitance (C_{DL}) characteristics. However, as the potential window is extended beyond 2.3 V, the CV curves deviated from the rectangular shape, suggesting the involvement of faradaic reactions, likely due to the water electrolysis. This transition indicates that while the supercapacitor can operate reversibly up to 2.3 V, exceeding this threshold introduces irreversible electrochemical processes that compromise its stability and performance.

In contrast, the performance in alkaline media was significantly inferior, with the specific capacitance and potential window being considerably narrower compared to acidic and neutral media. The combination of high specific capacitance and an extended operating potential range in acidic and neutral media represents a substantial breakthrough in developing advanced materials for supercapacitor applications, paving the way for more efficient and versatile energy storage systems.

The selection of the potential window is critical to maintaining high coulombic efficiency, as it helps avoid undesirable Faradaic reactions that can degrade the electrode material and reduce performance. The 3-electrode system results (FIG. 5B) reveal that the GONRs/Fe-MOFs composite in KOH exhibits a smaller potential window and significant peak separation, indicative of irreversible redox reactions. This makes it challenging to achieve high coulombic efficiency without restricting the potential window to 1.3 V, which ultimately compromises the composite's supercapacitive performance in alkaline electrolytes. In neutral electrolyte (0.7 M K₂SO₄), the GCD results show excellent capacitive performance, a wide safe potential window, and high capacitance, corroborating the earlier CV findings. The neutral electrolyte's ability to provide a stable and wide potential window without significant Faradaic side reactions makes it a promising candidate for supercapacitor applications. This is consistent with other reports emphasizing the advantages of neutral electrolytes in achieving high capacitance and long-term stability, as they minimize the risk of electrode degradation and gas evolution.

The obtained capacitance values across various electrolytes and current densities, reflecting the rate capability in the different electrolytes, derived from GCD measurements. The superior electrochemical performance of H₂SO₄ indicated by the high capacitance and less drop of the capacitance at higher current densities. According to the GCD results, the specific capacitance of the symmetric GONRs/Fe-MOFs//GONRs/Fe-MOFs devices were 107, 38, and 76 F/g 1 M H₂SO₄, 1 M KOH, and 0.7 M K₂SO₄ at a current density of 1 A/g, respectively. This reflects that the electrolyte considerably impacts the device's supercapacitive performance and guides the selection of the most suitable electrolyte that maximizes the benefits of the material under study, with H₂SO₄ emerging as the most effective electrolyte for maximizing capacitive performance in this system.

Additionally, FIG. 8C presents the Ragone plot for the GONRs/Fe-MOFs composite material at various current densities (1-10 A/g), displaying the calculated energy density (ED) and power density (PD) from the GCD results. ED is a crucial indicator of supercapacitor performance, derived using Equations 3 and 4, and depends on the electrodes' specific capacitance and operating potential. Theoretically, the maximum operating voltage in aqueous electrochemical supercapacitors is 1.23 V, linked to the water-splitting potential. However, designing and producing materials with high specific capacitance and an expanded operating potential range will have a high ED. The GONRs/Fe-MOFs composite exhibited a wide potential window of 2 and 2.3 V in acidic and neutral electrolytes, leading to high ED and PD and making it an excellent choice for symmetric aqueous supercapacitors. An ED of 60 Wh/kg and PD of 1027 W/kg was achieved in a 1 M H₂SO₄ electrolyte, ED of 58 Wh/kg and PD of 1207 W/kg was achieved in a 0.7 M K₂SO₄ electrolyte, and ED of 9.3 Wh/kg and PD of 677 W/kg was achieved in a 1 M KOH electrolyte at a current density of 1 A/g. The GONRs/Fe-MOFs composite exhibited comparable performance in 1 M H₂SO₄ and saturated K₂SO₄, superior to that in 1 M KOH. Remarkably, the material can provide substantially high energy (23 Wh/kg in H₂SO₄) and power (14596 W/kg in K₂SO₄) densities at current densities as high as 10 A/g, indicating efficient ion and electron transport.

FIG. 8D presents the EIS results at OCP in the form of Nyquist plots, with an inset depicting the equivalent circuit for fitting the data. Among the tested electrolytes, 1 M H₂SO₄ exhibits a Nyquist plot slope of 1.75 at low frequencies, higher than the slopes observed for K₂SO₄ (1.25) and 1 M KOH (1.39). This indicates easier ion diffusion in the acidic electrolyte and reflects lower diffusion resistance and more efficient ion transport at the electrode-electrolyte interface.

Table 4 reports the values of the circuit elements for the different electrolytes. The charge transfer resistance (Rct) at the surface of the prepared electrodes is found to be minimal value in the case of 1 M H₂SO₄; however, its value increased for the other types of electrolytes, indicating less resistance for charge transferring on the electrode surface for acidic electrolyte achieving higher contribution of the bulk to the net capacitance, by looking at PC and EDLC contributions (Q₂ and Q₃, respectively) (a) is the ideality factor, (the ideality extent of the constant phase element component) for different types of electrolytes in Table 4, Q₂ value, which is related to the PC contribution for 1M H₂SO₄ is higher the other electrolytes and its values are small compared to Q₃ values for different electrolytes indicates the significant contribution of the EDLC to the charge storage mechanism, Q₃ (EDLC) values follow the sequence H₂SO₄>KOH>K₂SO₄ indicates improved capacitance performance as a result of H⁺ ions penetrating the electrode material more profoundly and providing more access to the bulk. Ion diffusion limitation is evident in the diffusion part of the EIS response, represented by the Warburg component, with values of 19.3±0.09, 49.51±0.29, and 48.7±0.6 Ohm·s^{-1/2} for 1 M H₂SO₄, 1 M KOH, and saturated K₂SO₄, respectively. These values highlight the significant dependence of the devices' electric double-layer capacitance (EDLC) on ionic diffusion into the electrode bulk during the charge-storage process, affecting the capacitive performance, especially at high current densities. Consequently, the diffusion limitation of ions decreases specific capacitance at higher charging/discharging rates, with H₂SO₄ showing the least limitations over the other electrolytes due to the small size of H⁺ compared to K⁺.

TABLE 4
EIS fitting values for GONRs/Fe-MOFs composite symmetric device
in 1M H₂SO₄, 1M KOH, and saturated solution (≈0.7M) of K₂SO_{4.}

| | | Q₂ | | Q₃ | | |
|---|---|---|---|---|---|---|
| | R_{ct} (PC) | (PC) | | (EDLC) | | W |
| Electrolyte | (Ohm) | (μF · s^{(a-1)}) | (a₂) | (μF · s^{(a-1)}) | (a₃) | (Ohm · s^{-1/2}) |
| H₂SO₄ | 0.9 ± 0.005 | 7 ± 0.5 | 0.69 | 282 ± 10 | 1 | 19.3 ± 0.09 |
| KOH | 11.2 ± 0.22 | 0.3 ± 0.03 | 0.59 | 162 ± 0.5 | 1 | 49.51 ± 0.29 |
| K₂SO₄ | 8.5 ± 0.14 | 3.33 ± 0.001 | 0.57 | 143 ± 0.17 | 0.75 | 48.7 ± 0.6 |

The stability of the GONRs/Fe-MOFs composite as a symmetric device was evaluated by conducting GCD tests at a current density of 10 A/g for 10,000 cycles in different electrolytes, with capacitance retention (CR) shown in FIG. 8E. Even after 10,000 cycles, coulombic efficiency (CE) remained high at 99% for H₂SO₄, 97% for KOH, and 96% for K₂SO₄. The high CR across all the electrolytes demonstrates excellent GONRs/Fe-MOFs composite electrode stability in all tested conditions. Notably, in H₂SO₄, the CR increased above 100%, reaching 112%, likely due to electrode swelling during the 10,000 GCD cycles, resulting in higher capacitance than the initial cycles. For KOH, the CR was 99% after 10,000 cycles, and for K₂SO₄, the CR was 102%, indicating high stability and maintenance of most of the capacitance after cycling.

CVs were collected before and after the 10,000-cycle GCD test to emphasize electrode stability further, as shown in FIG. 8F. The electrodes maintained their capacitance even after 10,000 cycles in the various electrolytes, with the CVs exhibiting almost the same shape and size (increased in H₂SO₄ due to swelling), indicating no structural or compositional changes in the GONRs/Fe-MOFs composite. A comparative analysis of MOF-based electrode materials in two-electrode systems, shown in Table 5, highlights the energy storage performance of the GONRs/Fe-MOFs composite electrode focusing on cycling stability, energy density, power density, and capacitance retention (after 1000 cycles). Compared to the literature, this composite shows distinct advantages over the current electrode materials and devices. These results highlight the high potential of the GONRs/Fe-MOFs composite as materials for supercapacitor applications, particularly in neutral and acidic electrolytes.

TABLE 5
Comparison of the cycling stability with other previously reported electrode
materials with Fe-MOFs-containing electrodes in two electrode systems.

| | Cycle | Capacitance | Energy density | | Power density | | |
|---|---|---|---|---|---|---|---|
| Electrode material | number | Retention (%) | (Wh/kg) | | (kW/kg) | | Ref. |
| FeNP@MIL-101(Fe)/CNT | 10000 | 95.7% | 98.65 | | 9 | | others |
| Fe-MOF@AC | 10000 | 82% | 16.24 | | 0.89 | | others |
| Fe-MOF@Ni(OH)₂-20/NF//AC/NF | 4000 | 100% | 67.1 | | 0.8 | | others |
| Fe-MOF/CuO/C₃N₄ | 10000 | 87% | 55.09 @ 2 | A/g | 1.172 @ 2 | A/g | others |
| Fe-MOFs/GONRs 1M H₂SO₄ | 10000 | 112% | 60.1 @ 1 | A/g | 10.45 @ 10 | A/g | This Work |
| Fe-MOFs/GONRs 1M KOH | 10000 | 99% | 10.2 @ 1 | A/g | 8.3 @ 10 | A/g | This Work |
| Fe-MOFs/GONRs 0.7M K₂SO₄ | 10000 | 102% | 58 @ 1 | A/g | 14.62 @ 10 | A/g | This Work |

### CONCLUSION

Fe-MOFs, GONRs/Fe-MOFs materials were successfully synthesized, as confirmed by the XRD analysis. The presence of high redox active metal centers within the material was further confirmed by XPS analysis. The FT-IR analysis provided insights into the bonding interactions present in the composite material. GONRs/Fe-MOFs composite was utilized as electrodes for supercapacitors, showing remarkable electrochemical performance. After optimization, the Cₛ of the GONRs/Fe-MOFs composite was found to be 502, 493, and 403 F/g at a current density of 1 A/g in 1M H₂SO₄, saturated K₂SO₄, and 1M KOH. Even at a higher current density of 10 A/g, the Cs values were 295, 149, and 132 F/g, respectively, retaining most of their capacitance and indicating their suitability for supercapacitor applications. Additionally, the GONRs/Fe-MOFs//GONRs/Fe-MOFs were used to assemble symmetric supercapacitors, achieving maximum Cs of 107, 77, and 40 F/g and an energy density of 60.1, 58, and 10.2 Wh/kg at a current density of 1 A/g, and power density, at a current density of 10 A/g, of 10448, 8300, and 14620 W/kg in 1M H₂SO₄, saturated K₂SO₄, and 1M KOH, respectively. The synthesis method and the binder- and additive-free design make it a cost-effective candidate for electrode materials. Furthermore, the synergistic effects of the combination of Fe-MOFs and GONRs contribute to its suitability for supercapacitor applications. Therefore, synthesizing GONRs/Fe-MOFs composite materials at the molecular level is a promising technique for advancing practical energy storage applications.

What is claimed is:

1. A method of fabricating a supercapacitor electrode with enhanced electrochemical properties for energy storage systems, comprising:
(a) synthesizing solid samples of graphene oxide nanoribbons (GONRs) by oxidative unzipping of Multi-Walled Carbon Nanotubes (MWCNTs);
(b) hydrothermally making a powder of iron-metal-organic frameworks (Fe-MOFs) using a hydrothermal;
(c) physically mixing the solid samples of GONRs and powder of Fe-MOFs while maintaining a substantial weight ratio of 1:1 in the mixing of the solid samples and powder and thereby making a GONRs/Fe-MOFs composite; and
(d) ultrasonically mixing the physical mixing the GONRs/Fe-MOFs composite for at least 1 hour at about 300 Watt and at room temperature ranging from 24 degrees Celsius to 26 degrees Celsius.

2. The method as set forth in claim 1, the synthesizing graphene oxide nanoribbons (GONRs) step maintains a control temperature of less than 20 degrees Celsius during KMnO₄ addition.

3. The method as set forth in claim 1, wherein the supercapacitor electrode has a voltage range in an aqueous electrolyte in a range up to 2.3 Volts.
